(19) United States
(12) Patent Application Publication
(10) Pub. No.: US 2025/0096924 A1
(43) Pub. Date: Mar. 20, 2025

(54) NETWORK CODING FOR PACKET DATA CONVERGENCE PROTOCOL COMMUNICATIONS

(71) Applicant: QUALCOMM Incorporated, San Diego, CA (US)

(72) Inventors: Hyun Yong LEE, San Diego, CA (US); Prashanth Haridas HANDE, San Diego, CA (US); Sitaramanjaneyulu KANAMARLAPUDI, San Diego, CA (US); Jelena DAMNJANOVIC, Del Mar, CA (US); Peerapol TINNAKORNSRISUPHAP, San Diego, CA (US); Linhai HE, San Diego, CA (US); Mickael MONDET, Louannec (FR); Diana MAAMARI, San Diego, CA (US); Aziz GHOLMIEH, Del Mar, CA (US); Wei YANG, San Diego, CA (US)

(21) Appl. No.: 18/887,862

(22) Filed: Sep. 17, 2024

Related U.S. Application Data
(60) Provisional application No. 63/583,472, filed on Sep. 18, 2023.

(51) Int. Cl. H04L 1/00

(52) U.S. Cl. CPC H04L 1/0008; H04L 1/0041

(57) ABSTRACT

Various aspects of the present disclosure generally relate to wireless communication. In some aspects, a transmitting device may obtain a plurality of packet data convergence protocol (PDCP) packets. The transmitting device may generate a plurality of source symbols in accordance with applying a forward error correction encoding to the plurality of PDCP packets, wherein the plurality of source symbols are non-segmented outer coding source symbols. The transmitting device may transmit the plurality of source symbols. Numerous other aspects are described.

### CROSS-REFERENCE TO RELATED APPLICATION

This Patent application claims priority to U.S. Provisional Patent Application No. 63/583,472, filed on Sep. 18, 2023, entitled “NETWORK CODING FOR PACKET DATA CONVERGENCE PROTOCOL COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for network coding for packet data convergence protocol communications.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some aspects, a method of wireless communication performed by a transmitting device includes obtaining a plurality of packet data convergence protocol (PDCP) packets; generating a plurality of source symbols in accordance with applying a forward error correction encoding to the plurality of PDCP packets, wherein the plurality of source symbols are non-segmented outer coding source symbols; and transmitting, by a radio link control layer, the plurality of source symbols.

In some aspects, a method of wireless communication performed by a transmitting device includes obtaining a plurality of PDCP packets; generating a plurality of outer coding symbols in accordance with a maximum PDCP packet size of the plurality of PDCP packets; adjusting a PDCP packet size, for one or more PDCP packets not having the maximum PDCP packet size, to be equal to an outer coding symbol size of the plurality of outer coding symbols; and transmitting the plurality of PDCP packets in accordance with adjusting the PDCP packet size.

In some aspects, a method of wireless communication performed by a transmitting device includes obtaining a plurality of PDCP packets; applying, in accordance with a difference between a PDCP packet size associated with the plurality of PDCP packets and an outer coding symbol size associated with a plurality of outer coding symbols, a zero padding to the plurality of outer coding symbols; and transmitting the outer coding block in accordance with applying the zero padding to the plurality of outer coding symbols.

In some aspects, a method of wireless communication performed by a receiving device includes receiving a plurality of radio link control (RLC) packets; identifying that the plurality of RLC packets are segmented by an outer coding symbol size; generating a plurality of source symbols in accordance with the plurality of RLC packets and the outer coding symbol size; and processing the plurality of source symbols to obtain a plurality of PDCP packets.

In some aspects, a method of wireless communication performed by a receiving device includes receiving a plurality of RLC protocol data units (PDUs); estimating a zero padding length for a plurality of outer coding symbols in accordance with a difference between an RLC PDU size associated with the plurality of RLC PDUs and an outer coding symbol size associated with a plurality of outer coding symbols; and processing the plurality of outer coding symbols in accordance with the zero padding length to obtain a plurality of PDCP PDUs.

In some aspects, an apparatus for wireless communication at a transmitting device includes one or more memories; and one or more processors coupled to the one or more memories, the one or more processors individually or collectively configured to cause the transmitting device to: obtain a plurality of PDCP packets; generate a plurality of source symbols in accordance with applying a forward error correction encoding to the plurality of PDCP packets, wherein the plurality of source symbols are non-segmented outer coding source symbols; and transmit the plurality of source symbols.

In some aspects, an apparatus for wireless communication at a transmitting device includes one or more memories; and one or more processors coupled to the one or more memories, the one or more processors individually or collectively configured to cause the transmitting device to: obtain a plurality of PDCP packets; generate a plurality of outer coding symbols in accordance with a maximum PDCP packet size of the plurality of PDCP packets; adjust a PDCP packet size, for one or more PDCP packets not having the maximum PDCP packet size, to be equal to an outer coding symbol size of the plurality of outer coding symbols; and transmit the plurality of PDCP packets in accordance with adjusting the PDCP packet size.

In some aspects, an apparatus for wireless communication at a transmitting device includes one or more memories; and one or more processors coupled to the one or more memories, the one or more processors individually or collectively configured to cause the transmitting device to: obtain a plurality of PDCP packets; apply, in accordance with a difference between a PDCP packet size associated with the plurality of PDCP packets and an outer coding symbol size associated with a plurality of outer coding symbols, a zero padding to the plurality of outer coding symbols; and transmit the outer coding block in accordance with applying the zero padding to the plurality of outer coding symbols.

In some aspects, an apparatus for wireless communication at a receiving device includes one or more memories; and one or more processors coupled to the one or more memories, the one or more processors individually or collectively configured to cause the receiving device to: receive a plurality of RLC packets; identify that the plurality of RLC packets are segmented by an outer coding symbol size; generate a plurality of source symbols in accordance with the plurality of RLC packets and the outer coding symbol size; and process the plurality of source symbols to obtain a plurality of PDCP packets.

In some aspects, an apparatus for wireless communication at a receiving device includes one or more memories; and one or more processors coupled to the one or more memories, the one or more processors individually or collectively configured to cause the receiving device to: receive a plurality of RLC PDUs; estimate a zero padding length for a plurality of outer coding symbols in accordance with a difference between an RLC PDU size associated with the plurality of RLC PDUs and an outer coding symbol size associated with a plurality of outer coding symbols; and process the plurality of outer coding symbols in accordance with the zero padding length to obtain a plurality of PDCP PDUs.

In some aspects, a non-transitory computer-readable medium storing a set of instructions for wireless communication includes one or more instructions that, when executed by one or more processors of a transmitting device, cause the transmitting device to: obtain a plurality of PDCP packets; generate a plurality of source symbols in accordance with applying a forward error correction encoding to the plurality of PDCP packets, wherein the plurality of source symbols are non-segmented outer coding source symbols; and transmit the plurality of source symbols.

In some aspects, a non-transitory computer-readable medium storing a set of instructions for wireless communication includes one or more instructions that, when executed by one or more processors of a transmitting device, cause the transmitting device to: obtain a plurality of PDCP packets; generate a plurality of outer coding symbols in accordance with a maximum PDCP packet size of the plurality of PDCP packets; adjust a PDCP packet size, for one or more PDCP packets not having the maximum PDCP packet size, to be equal to an outer coding symbol size of the plurality of outer coding symbols; and transmit the plurality of PDCP packets in accordance with adjusting the PDCP packet size.

In some aspects, a non-transitory computer-readable medium storing a set of instructions for wireless communication includes one or more instructions that, when executed by one or more processors of a transmitting device, cause the transmitting device to: obtain a plurality of PDCP packets; apply, in accordance with a difference between a PDCP packet size associated with the plurality of PDCP packets and an outer coding symbol size associated with a plurality of outer coding symbols, a zero padding to the plurality of outer coding symbols; and transmit the outer coding block in accordance with applying the zero padding to the plurality of outer coding symbols.

In some aspects, a non-transitory computer-readable medium storing a set of instructions for wireless communication includes one or more instructions that, when executed by one or more processors of a receiving device, cause the receiving device to: receive a plurality of RLC packets; identify that the plurality of RLC packets are segmented by an outer coding symbol size; generate a plurality of source symbols in accordance with the plurality of RLC packets and the outer coding symbol size; and process the plurality of source symbols to obtain a plurality of PDCP packets.

In some aspects, a non-transitory computer-readable medium storing a set of instructions for wireless communication includes one or more instructions that, when executed by one or more processors of a receiving device, cause the receiving device to: receive a plurality of RLC PDUs; estimate a zero padding length for a plurality of outer coding symbols in accordance with a difference between an RLC PDU size associated with the plurality of RLC PDUs and an outer coding symbol size associated with a plurality of outer coding symbols; and process the plurality of outer coding symbols in accordance with the zero padding length to obtain a plurality of PDCP PDUs.

In some aspects, an apparatus for wireless communication includes means for obtaining a plurality of PDCP packets; means for generating a plurality of source symbols in accordance with applying a forward error correction encoding to the plurality of PDCP packets, wherein the plurality of source symbols are non-segmented outer coding source symbols; and means for transmitting the plurality of source symbols.

In some aspects, an apparatus for wireless communication includes means for obtaining a plurality of PDCP packets; means for generating a plurality of outer coding symbols in accordance with a maximum PDCP packet size of the plurality of PDCP packets; means for adjusting a PDCP packet size, for one or more PDCP packets not having the maximum PDCP packet size, to be equal to an outer coding symbol size of the plurality of outer coding symbols; and means for transmitting the plurality of PDCP packets in accordance with adjusting the PDCP packet size.

In some aspects, an apparatus for wireless communication includes means for obtaining a plurality of PDCP packets; means for applying, in accordance with a difference between a PDCP packet size associated with the plurality of PDCP packets and an outer coding symbol size associated with a plurality of outer coding symbols, a zero padding to the plurality of outer coding symbols; and means for transmitting the outer coding block in accordance with applying the zero padding to the plurality of outer coding symbols.

In some aspects, an apparatus for wireless communication includes means for receiving a plurality of RLC packets; means for identifying that the plurality of RLC packets are segmented by an outer coding symbol size; generating a plurality of source symbols in accordance with the plurality of RLC packets and the outer coding symbol size; and means for processing the plurality of source symbols to obtain a plurality of PDCP packets.

In some aspects, an apparatus for wireless communication includes means for receiving a plurality of RLC PDUs; means for estimating a zero padding length for a plurality of outer coding symbols in accordance with a difference between an RLC PDU size associated with the plurality of RLC PDUs and an outer coding symbol size associated with a plurality of outer coding symbols; and means for processing the plurality of outer coding symbols in accordance with the zero padding length to obtain a plurality of PDCP PDUs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a user plane protocol stack and a control plane protocol stack for a network node and a core network in communication with a UE, in accordance with the present disclosure.

FIG. 5 is a diagram illustrating examples of retransmissions and outer coding, in accordance with the present disclosure.

FIG. 6 is a diagram illustrating an example of protocol data units and protocol data unit sets, in accordance with the present disclosure.

FIG. 7 is a diagram illustrating an example of outer coding, in accordance with the present disclosure.

FIG. 8 is a diagram illustrating an example of an outer coding block assembly with outer coding source symbol segmentation, in accordance with the present disclosure.

FIG. 9 is a diagram illustrating an example of an outer coding block assembly without outer coding source symbol segmentation, in accordance with the present disclosure.

FIG. 10 is a diagram illustrating an example of an outer coding block assembly, in accordance with the present disclosure.

FIG. 11 is a diagram illustrating an example of adjusting an outer coding symbol size, in accordance with the present disclosure.

FIG. 12 is a diagram illustrating an example of radio link control packet transmission using maximum packet data convergence protocol packet size, in accordance with the present disclosure.

FIG. 13 is a diagram illustrating an example of zero padding for segmented outer coding symbols, in accordance with the present disclosure.

FIGS. 14A-14B are diagrams illustrating examples of zero padding performed by a transmitting device and a receiving device, in accordance with the present disclosure.

FIG. 15 is a diagram illustrating an example of zero padding for outer coding symbols, in accordance with the present disclosure.

FIG. 16 is a diagram illustrating an example process performed, for example, at a transmitting device or an apparatus of a transmitting device, in accordance with the present disclosure.

FIG. 17 is a diagram illustrating an example process performed, for example, at a transmitting device or an apparatus of a transmitting device, in accordance with the present disclosure.

FIG. 18 is a diagram illustrating an example process performed, for example, at a transmitting device or an apparatus of a transmitting device, in accordance with the present disclosure.

FIG. 19 is a diagram illustrating an example process performed, for example, at a receiving device or an apparatus of a receiving device, in accordance with the present disclosure.

FIG. 20 is a diagram illustrating an example process performed, for example, at a receiving device or an apparatus of a receiving device, in accordance with the present disclosure.

FIG. 21 is a diagram of an example apparatus for wireless communication, in accordance with the present disclosure.

FIG. 22 is a diagram of an example apparatus for wireless communication, in accordance with the present disclosure.

### DETAILED DESCRIPTION

Outer coding may be used to improve latency and reduce power consumption for protocol data unit (PDU) transmissions. In some cases, performing outer coding may include using a forward error correction (FEC) to add one or more parity symbols to a PDU set, such as after a last slot or symbol of the PDU set. The parity symbols may include redundant information associated with the PDU set transmission, and may improve a recovery probability for the PDU set without introducing delays associated with hybrid automatic repeat request (HARQ) retransmissions. A PDU is a unit of data that can vary in accordance with a protocol or layer within a protocol stack. For example, at a networking layer, a PDU may be referred to as a packet. A packet may include data associated with the PDU and may include header information for routing, error checking, and control functions, among other examples. Certain applications may consume data in PDU sets (rather than in individual IP packets). For example, an extended reality (XR) application may consume one video frame per burst or multiple slices of a video frame per burst. In some cases, a PDU set may include a plurality of Internet Protocol (IP) packets that correspond to a unit of information for the application. For example, the PDU set may include a slice of a video frame that can be FEC protected by adding one or more parity bits to the PDU set. In some cases, FEC may be applied to multiple packet data convergence protocol (PDCP) PDUs (e.g., multiple PDU sets). This may allow for increased granularity for FEC protection and may improve a probability of recovering a PDU set (e.g., in case of an error during a transmission of the PDU set).

In some cases, an outer coding (OC) sublayer that is configured to perform FEC encoding may receive an input that includes a PDU set and at least one of service data application protocol (SDAP) or PDCP header information. The OC sublayer may generate an OC block based at least in part on the PDU set and the header information. The OC block may include one or more source symbols and one or more parity symbols. The one or more source symbols and/or the one or more parity symbols may have an OC symbol size, for example, in accordance with an OC symbol size indicated in a PDCP header. In some cases, a transmitting device (such as a network node) may transmit an OC block to a receiving device (such as a user equipment (UE)). However, the transmitting device may not be configured with information that enables the transmitting device to construct the OC block from the multiple PDCP packets. For example, the transmitting device may not be configured with mapping rules that enable the transmitting device to map the IP packets to the OC symbols. Additionally, the transmitting device and/or the receiving device may not be configured to align a PDCP packet size with the OC symbol size. For example, the OC symbol size may be determined by a radio access network (RAN), whereas the PDCP packet size may be determined by an application layer. IP packets included in a PDU set may have different sizes, whereas each OC symbol within an OC block may have the same OC symbol size. This may result in the IP packets having a different size than the OC symbols. The transmitting device and the receiving device may not be configured with information that enables the transmitting device and the receiving device to generate OC symbols having a same size as the PDCP packets. This may result in transmission errors that may require HARQ retransmissions, thereby increasing latency and power consumption at the transmitting device and the receiving device.

Various aspects relate generally to wireless communications. Some aspects more specifically relate to network coding for packet data convergence protocol communications. In some aspects, a transmitting device may receive a plurality of PDCP packets. The transmitting device may be a network node, a UE, or any other communication device, and the plurality of PDCP packets may be a plurality of PDCP PDUs. The transmitting device may generate a plurality of source symbols in accordance with applying an FEC to the plurality of PDCP packets. Generating the plurality of source symbols may include generating a plurality of non-segmented outer coding source symbols. The transmitting device may transmit the plurality of source symbols to a receiving device. The receiving device may be a network node, a UE, or any other communication device. In some aspects, the transmitting device may obtain a plurality of PDCP packets and may generate a plurality of outer coding symbols in accordance with a maximum PDCP packet size of the plurality of PDCP packets. The transmitting device may adjust a PDCP packet size, for one or more PDCP packets not having the maximum PDCP packet size, to be equal to an outer coding symbol size associated with the plurality of outer coding symbols. In one example, the transmitting device may apply one or more zero padding bits to each PDCP packet not having the maximum PDCP packet size. In some aspects, the transmitting device may obtain a plurality of PDCP packets and may calculate a difference between a PDCP packet size associated with the plurality of PDCP packets and an outer coding symbol size associated with a plurality of outer coding symbols. The transmitting device may apply a zero padding to at least one of the outer coding block or the plurality of outer coding symbols, and may transmit the outer coding block in accordance with applying the zero padding. In a first example, applying the zero padding may include applying one or more zero padding bits to an end of the outer coding block. In a second example, applying the zero padding may include applying one or more zero padding bits to an end of each outer coding symbol of the plurality of outer coding symbols. In some aspects, a receiving device may receive a plurality of RLC packets and may identify that the plurality of RLC packets are to be segmented by an outer coding symbol size. The receiving device may generate a plurality of source symbols in accordance with the plurality of RLC packets and the outer coding symbol size.

Particular aspects of the subject matter described in this disclosure can be implemented to realize one or more of the following potential advantages. In some examples, by generating a plurality of source symbols in accordance with a plurality of PDCP packets, the described techniques can be used to generate an outer coding block that includes a plurality of PDCP packets and associated headers. Additionally, by generating the plurality of source symbols and transmitting the plurality of source symbols without performing outer coding symbol segmentation, network overhead, such as RLC layer overhead and outer coding processing overhead, may be reduced. In some aspects, by generating a plurality of outer coding symbols in accordance with a maximum PDCP packet size, and adjusting a PDCP packet size for one or more PDCP packets not having the maximum PDCP packet size, concatenation and segmentation requirements for PDCP packet transmissions may be reduced or eliminated. In some aspects, by applying a zero padding to a plurality of outer coding symbols in accordance with a difference between a PDCP packet size and an outer coding symbol size, the described techniques can be used to align the PDCP packet size and the outer coding symbol size, which may reduce a likelihood of transmission errors. Additionally, by transmitting the outer coding block while refraining from transmitting the zero padding symbols, network overhead and radio resource consumption may be reduced. In some aspects, by identifying that a plurality of RLC packets are segmented by an outer coding symbol size, and generating a plurality of source symbols in accordance with the outer coding symbol size, network overhead may be reduced, for example, by reducing or eliminating outer coding symbol transmissions over the air. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

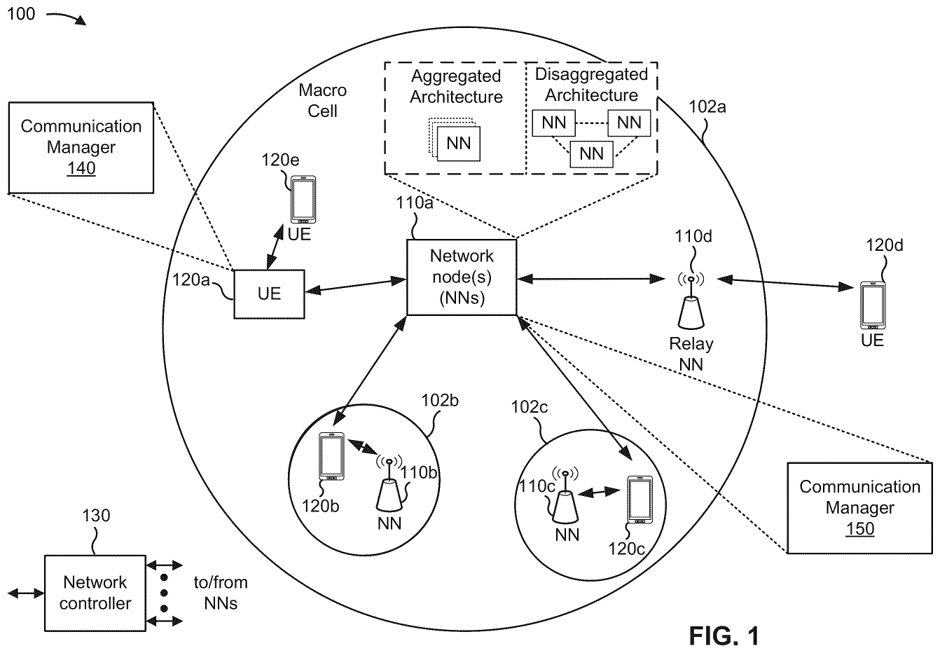

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (Dus), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a network node 110 may include a communication manager 150. As described in more detail elsewhere herein, the communication manager 150 may obtain a plurality of PDCP packets; generate a plurality of source symbols in accordance with applying a forward error correction encoding to the plurality of PDCP packets, wherein the plurality of source symbols are non-segmented outer coding source symbols; and transmit the plurality of source symbols. In some other aspects, as described in more detail elsewhere herein, the communication manager 150 may obtain a plurality of PDCP packets; generate a plurality of outer coding symbols in accordance with a maximum PDCP packet size of the plurality of PDCP packets; adjust a PDCP packet size, for one or more PDCP packets not having the maximum PDCP packet size, to be equal to an outer coding symbol size of the plurality of outer coding symbols; and transmit the plurality of PDCP packets in accordance with adjusting the PDCP packet size. In some other aspects, as described in more detail elsewhere herein, the communication manager 150 may obtain a plurality of PDCP packets; apply, in accordance with a difference between a PDCP packet size associated with the plurality of PDCP packets and an outer coding symbol size associated with a plurality of outer coding symbols, a zero padding to the plurality of outer coding symbols; and transmit the outer coding block in accordance with applying the zero padding to the plurality of outer coding symbols. In some other aspects, as described in more detail elsewhere herein, the communication manager 150 may receive a plurality of RLC packets; identify that the plurality of RLC packets are segmented by an outer coding symbol size; generate a plurality of source symbols in accordance with the plurality of RLC packets and the outer coding symbol size; and process the plurality of source symbols to obtain a plurality of PDCP packets. In some other aspects, as described in more detail elsewhere herein, the communication manager 150 may receive a plurality of RLC PDUs; estimate a zero padding length for a plurality of outer coding symbols in accordance with a difference between an RLC PDU size associated with the plurality of RLC PDUs and an outer coding symbol size associated with a plurality of outer coding symbols; and process the plurality of outer coding symbols in accordance with the zero padding length to obtain a plurality of PDCP PDUs. Additionally, or alternatively, the communication manager 150 may perform one or more other operations described herein.

In some aspects, a UE 120 may include a communication manager 140. As described in more detail elsewhere herein, the communication manager 140 may obtain a plurality of PDCP packets; generate a plurality of source symbols in accordance with applying a forward error correction encoding to the plurality of PDCP packets, wherein the plurality of source symbols are non-segmented outer coding source symbols; and transmit the plurality of source symbols. In some other aspects, as described in more detail elsewhere herein, the communication manager 140 may obtain a plurality of PDCP packets; generate a plurality of outer coding symbols in accordance with a maximum PDCP packet size of the plurality of PDCP packets; adjust a PDCP packet size, for one or more PDCP packets not having the maximum PDCP packet size, to be equal to an outer coding symbol size of the plurality of outer coding symbols; and transmit the plurality of PDCP packets in accordance with adjusting the PDCP packet size. In some other aspects, as described in more detail elsewhere herein, the communication manager 140 may obtain a plurality of PDCP packets; apply, in accordance with a difference between a PDCP packet size associated with the plurality of PDCP packets and an outer coding symbol size associated with a plurality of outer coding symbols, a zero padding to the plurality of outer coding symbols; and transmit the outer coding block in accordance with applying the zero padding to the plurality of outer coding symbols. In some other aspects, as described in more detail elsewhere herein, the communication manager 140 may receive a plurality of RLC packets; identify that the plurality of RLC packets are segmented by an outer coding symbol size; generate a plurality of source symbols in accordance with the plurality of RLC packets and the outer coding symbol size; and process the plurality of source symbols to obtain a plurality of PDCP packets. In some other aspects, as described in more detail elsewhere herein, the communication manager 140 may receive a plurality of RLC PDUs; estimate a zero padding length for a plurality of outer coding symbols in accordance with a difference between an RLC PDU size associated with the plurality of RLC PDUs and an outer coding symbol size associated with a plurality of outer coding symbols; and process the plurality of outer coding symbols in accordance with the zero padding length to obtain a plurality of PDCP PDUs. Additionally, or alternatively, the communication manager 140 may perform one or more other operations described herein.

As indicated above, FIG. 1 is provided as an example. Other examples may differ from what is described with regard to FIG. 1.

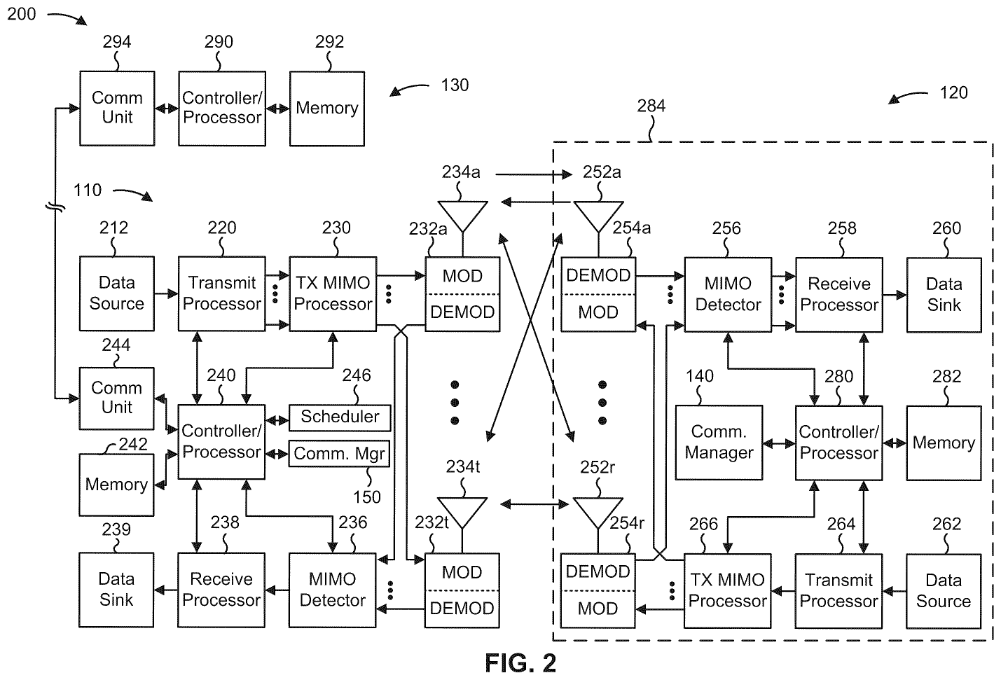

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

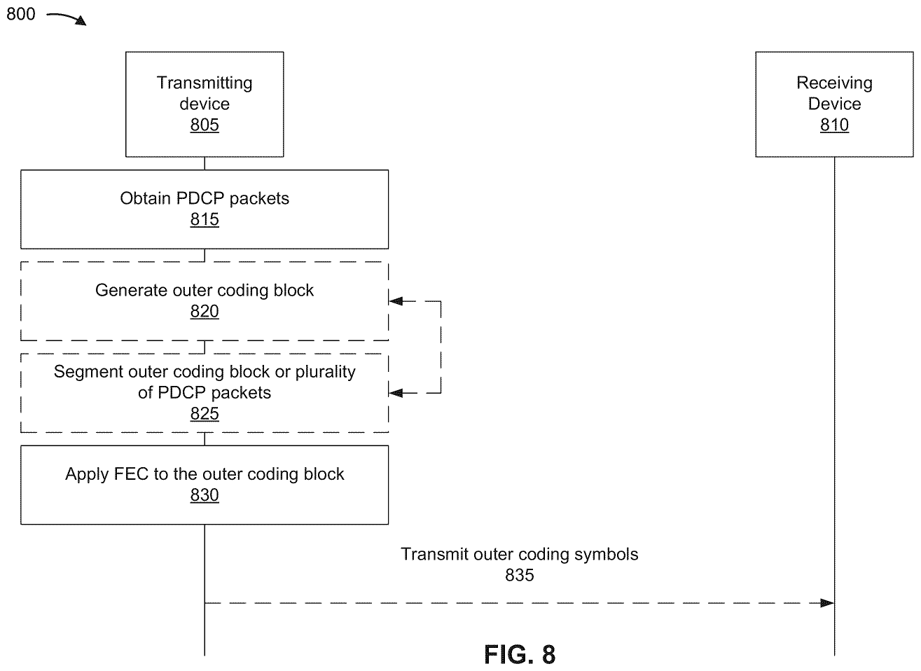

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 8-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 8-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

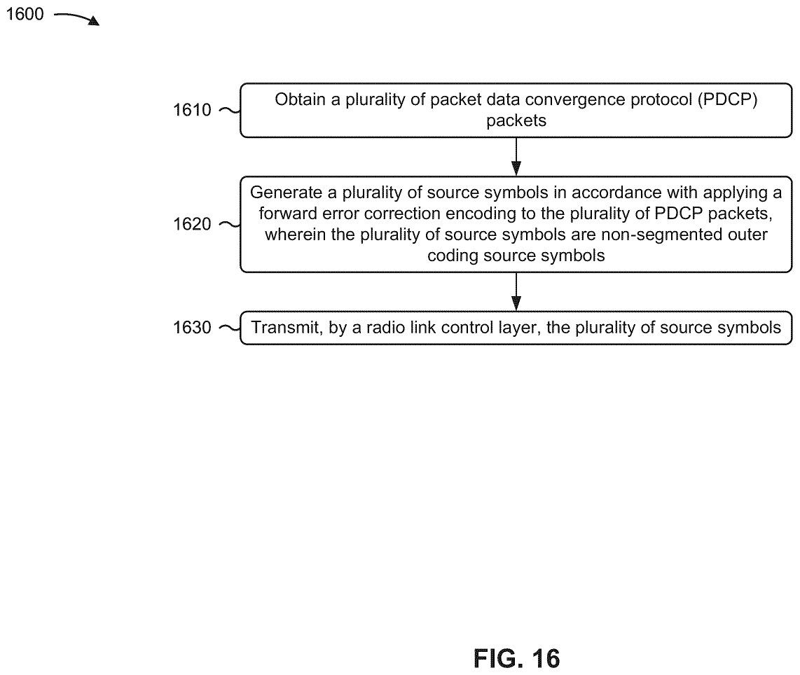

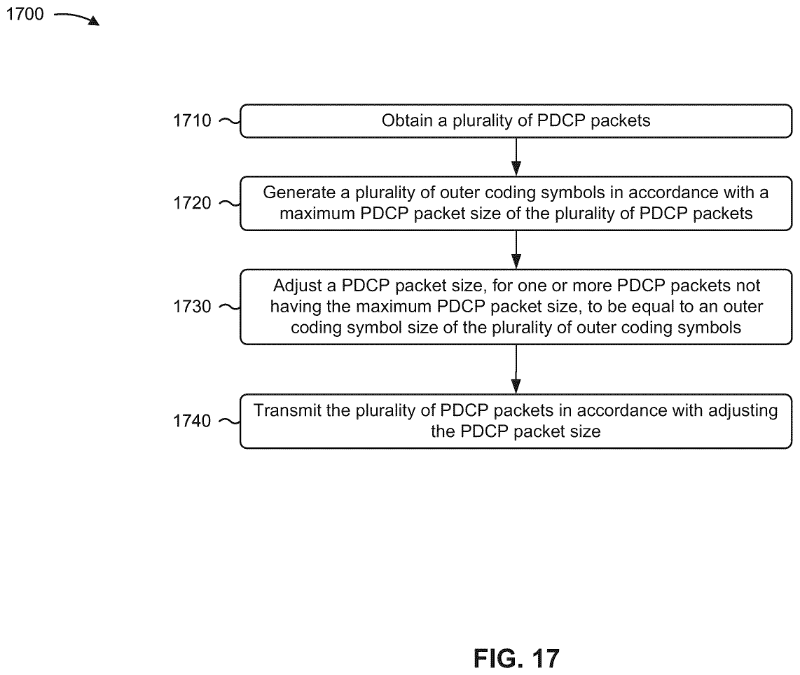

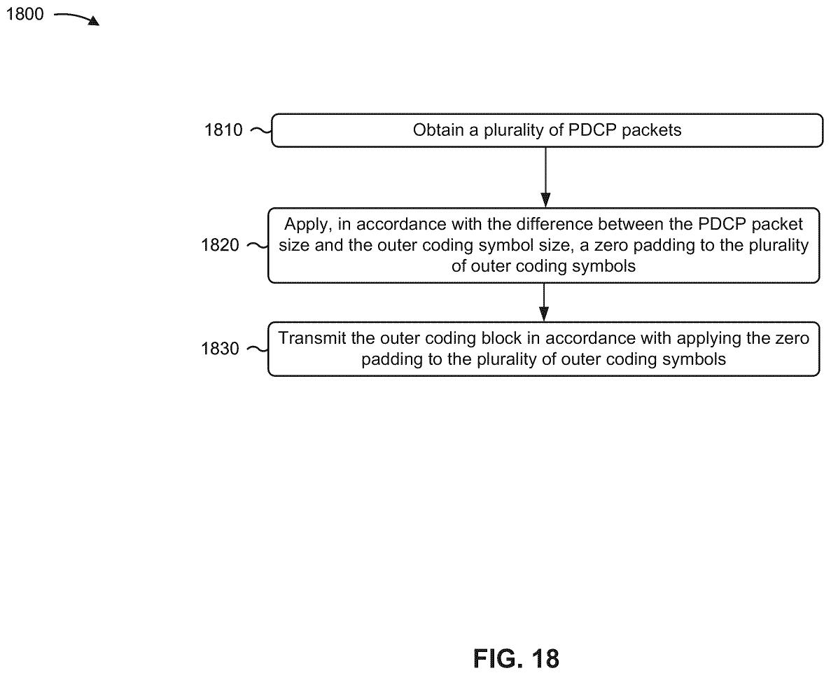

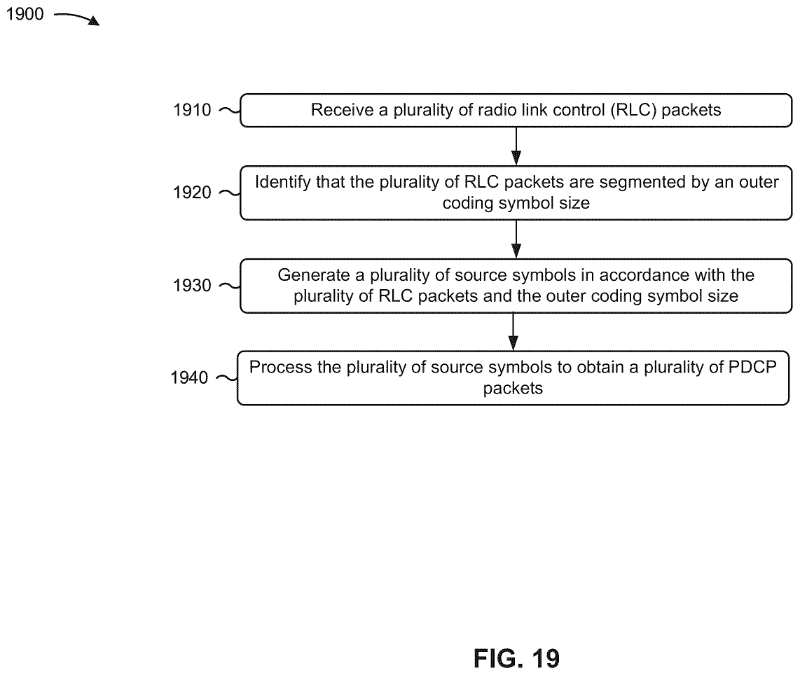

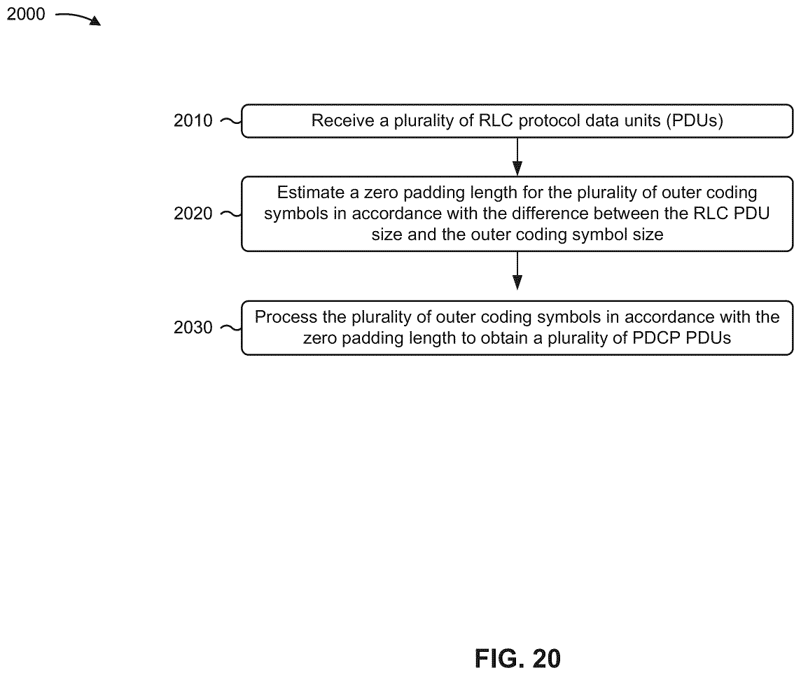

The controller/processor 240 of the network node 110, the controller/processor 280 of the UE 120, or any other component(s) of FIG. 2 may perform one or more techniques associated with network coding for packet data convergence protocol communications, as described in more detail elsewhere herein. In some aspects, the transmitting device described herein is the network node 110, is included in the network node 110, or includes one or more components of the network node 110 shown in FIG. 2. In some other aspects, the transmitting device described herein is the UE 120, is included in the UE 120, or includes one or more components of the UE 120 shown in FIG. 2. In some aspects, the receiving device described herein is the network node 110, is included in the network node 110, or includes one or more components of the network node 110 shown in FIG. 2. In some other aspects, the receiving device described herein is the UE 120, is included in the UE 120, or includes one or more components of the UE 120 shown in FIG. 2. For example, the controller/processor 240 of the network node 110, the controller/processor 280 of the UE 120, or any other component(s) (or combinations of components) of FIG. 2 may perform or direct operations of, for example, process 1600 of FIG. 16, process 1700 of FIG. 17, process 1800 of FIG. 18, process 1900 of FIG. 19, process 2000 of FIG. 20, and/or other processes as described herein, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1600 of FIG. 16, process 1700 of FIG. 17, process 1800 of FIG. 18, process 1900 of FIG. 19, process 2000 of FIG. 20, and/or other processes as described herein, and/or other processes as described herein. In some examples, executing instructions may include running the instructions, converting the instructions, compiling the instructions, and/or interpreting the instructions, among other examples.

In some aspects, the transmitting device (e.g., the network node 110 or the UE 120) includes means for obtaining a plurality of PDCP packets; means for generating a plurality of source symbols in accordance with applying a forward error correction encoding to the plurality of PDCP packets, wherein the plurality of source symbols are non-segmented outer coding source symbols; and/or means for transmitting, by a radio link control layer, the plurality of source symbols. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the transmitting device (e.g., the network node 110 or the UE 120) includes means for obtaining a plurality of PDCP packets; means for generating a plurality of outer coding symbols in accordance with a maximum PDCP packet size of the plurality of PDCP packets; means for adjusting a PDCP packet size, for one or more PDCP packets not having the maximum PDCP packet size, to be equal to an outer coding symbol size of the plurality of outer coding symbols; and/or means for transmitting the plurality of PDCP packets in accordance with adjusting the PDCP packet size. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the transmitting device (e.g., the network node 110 or the UE 120) includes means for obtaining a plurality of PDCP packets; means for applying, in accordance with a difference between a PDCP packet size associated with the plurality of PDCP packets and an outer coding symbol size associated with a plurality of outer coding symbols, a zero padding to the plurality of outer coding symbols; and/or means for transmitting the outer coding block in accordance with applying the zero padding to the plurality of outer coding symbols. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receiving device (e.g., the network node 110 or the UE 120) includes means for receiving a plurality of RLC packets; means for identifying that the plurality of RLC packets are segmented by an outer coding symbol size; means for generating a plurality of source symbols in accordance with the plurality of RLC packets and the outer coding symbol size; and/or means for processing the plurality of source symbols to obtain a plurality of PDCP packets. In some aspects, the means for the receiving device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receiving device (e.g., the network node 110 or the UE 120) includes means for receiving a plurality of RLC PDUs; means for estimating a zero padding length for a plurality of outer coding symbols in accordance with a difference between an RLC PDU size associated with the plurality of RLC PDUs and an outer coding symbol size associated with a plurality of outer coding symbols; and/or means for processing the plurality of outer coding symbols in accordance with the zero padding length to obtain a plurality of PDCP PDUs. In some aspects, the means for the receiving device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

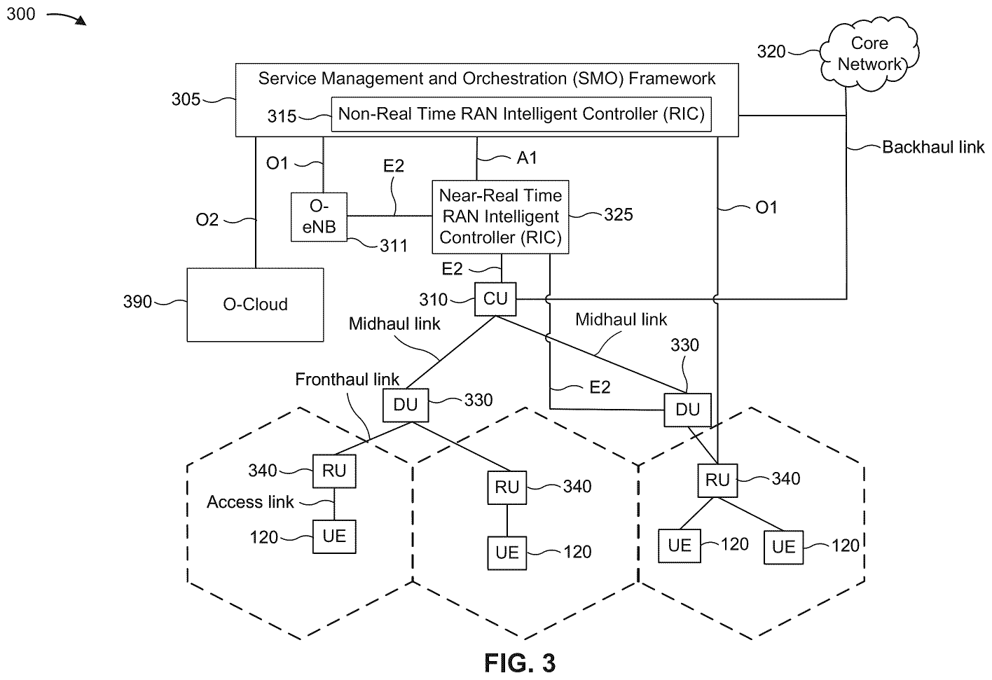

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

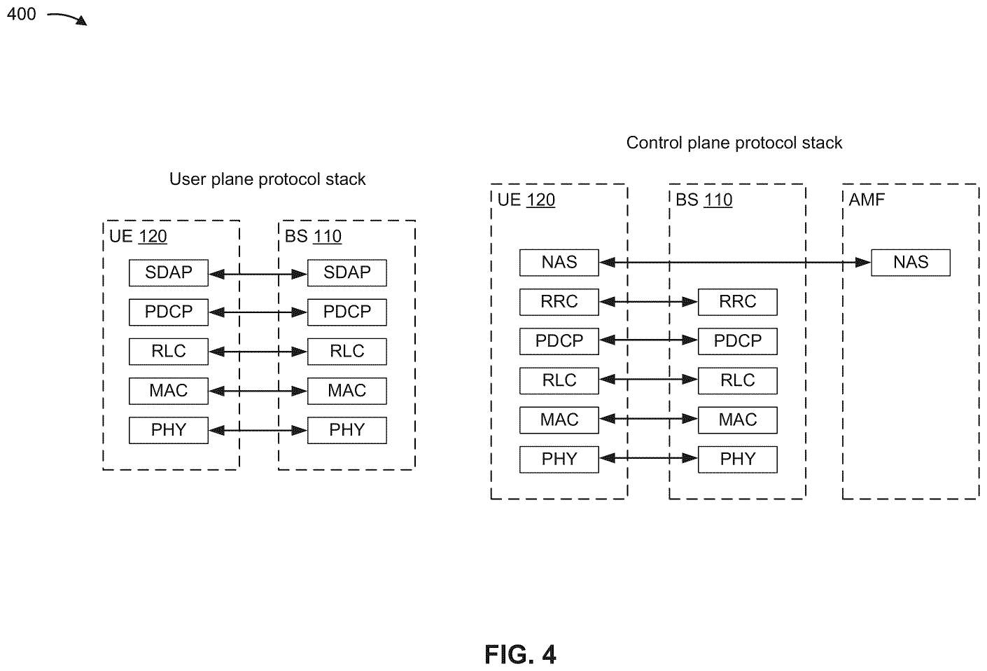

FIG. 4 is a diagram illustrating an example 400 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the network node 110. On the control plane, the UE 120 and the network node 110 may include respective radio resource control (RRC) layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QOS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 4 is provided as an example. Other examples may differ from what is described with regard to FIG. 4.

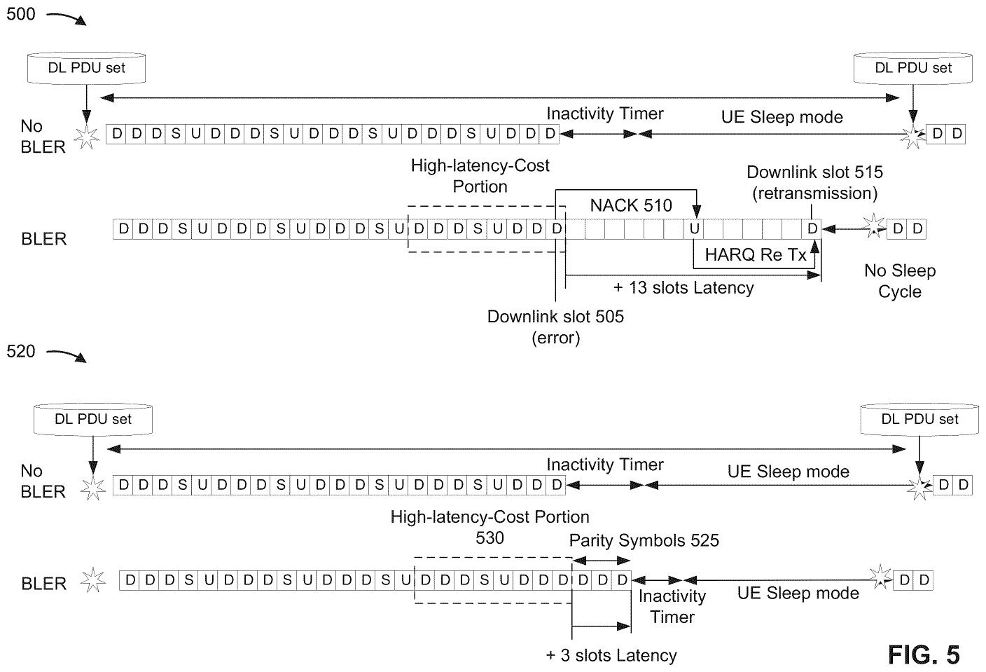

FIG. 5 is a diagram illustrating examples of retransmissions and outer coding, in accordance with the present disclosure.

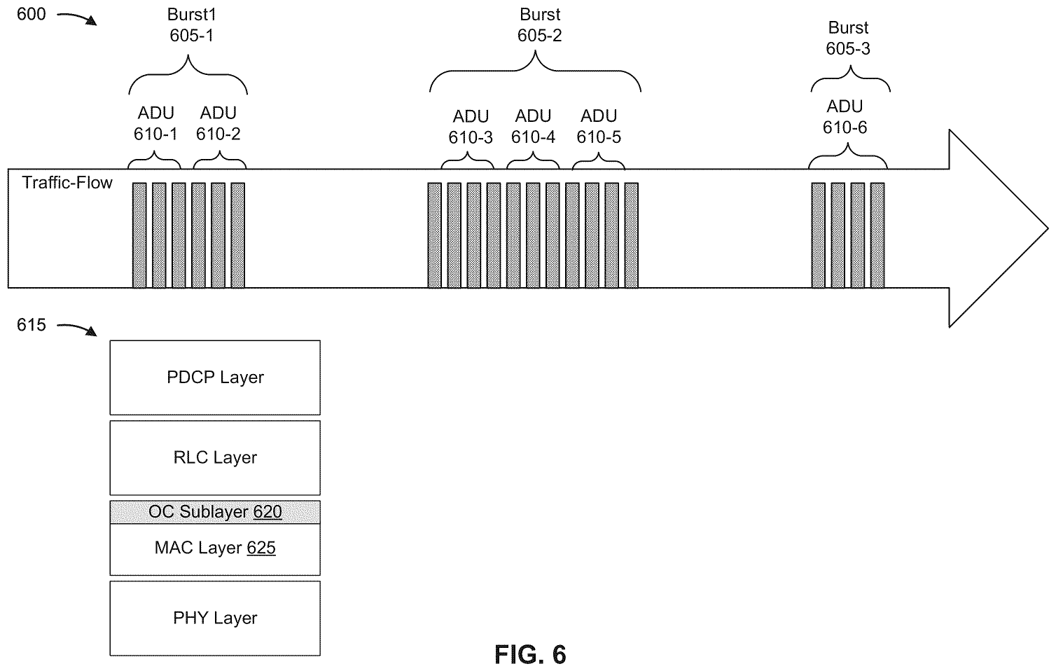

A network node may perform a downlink transmission that includes a PDU set. In some cases, the PDU set may have strict latency and power requirements, such as in the example where the PDU set is associated with an extended reality (XR) application. For example, the PDU set may have a packet delay budget (PDB) of ten milliseconds (ms) and may have a power consumption requirement of less than 1 watt (W). Additional details regarding PDU sets are described in connection with FIG. 6.

In some cases, an error may occur during a transmission of a PDU set. In this case, a retransmission of one or more slots of the PDU set may be used for error correction. The retransmission may be, for example, an automatic repeat request (ARQ) retransmission or a hybrid ARQ (HARQ) retransmission. However, this may add latency and may require additional power for the PDU set transmissions. As shown in example 500, a PDU set may include a plurality of downlink slots (D), uplink slots (U), and special slots(S). In one example, the plurality of slots may include 23 slots. After a transmission of the PDU set with no block error rate (BLER), a UE may initiate an inactivity timer, and may enter into a sleep mode after an expiration of the inactivity timer. This may enable the UE to conserve energy resources. However, for a PDU set with a BLER, a downlink slot 505 of the PDU set may not be successfully received by the UE. In this case, the UE may transmit a negative acknowledgement (NACK) 510 seven slots after the downlink slot 505 (e.g., the last slot of the PDU set), and a retransmission 515 of the downlink slot 505 may occur six slots after the NACK 510. This may introduce a latency of thirteen slots (about 35 ms) and may prevent the UE from initiating the inactivity timer and entering the sleep mode.

In some cases, outer coding may be used to improve latency and reduce power consumption for PDU set transmissions. Outer coding may include using a forward error correction (FEC) to add one or more parity symbols to a PDU set (e.g., after a last slot or symbol of the PDU set). The parity symbols may include redundant information associated with the PDU set transmission, and may improve a recovery probability for the PDU set without introducing delays associated with HARQ retransmissions. As shown in example 520, for a PDU set with a BLER, parity symbols 525 may be added to an end of the PDU set. The parity symbols 525 may include redundant information from a high-latency-cost portion 530 of the PDU set. The parity symbols 525 may introduce a latency of three slots to the PDU set transmission, which may allow for the UE to initiate the inactivity timer and enter a sleep mode for conserving UE power resources.

As indicated above, FIG. 5 is provided as an example. Other examples may differ from what is described with regard to FIG. 5.

FIG. 6 is a diagram illustrating an example of protocol data units and protocol data unit sets, in accordance with the present disclosure.

An application data unit (ADU) may be generated by an application (e.g., an XR application) and may include content to be transmitted over a network. The ADU may include text, images, video, audio, or any application-layer data to be transmitted over the network. In contrast, a PDU is a unit of data that can vary in accordance with a specific protocol or layer within a protocol stack. At a networking layer (e.g., Layer 3), a PDU may be referred to as a packet. A packet may include data associated with the PDU and may include header information for routing, error checking, and control functions, among other examples. Certain applications may consume data in PDU sets (rather than individual IP packets). For example, an XR application may consume one video frame per burst, or multiple slices of a video frame per burst, among other examples. A burst may include a set of IP packets or ADUs that are to be delivered to a device at a same time. For example, the burst may include all slices of a video frame. As shown in example 600, burst 605 may include one or more ADUs 610. For example, burst 605-1 may include ADU 610-1 and 610-2, burst 605-2 may include ADU 610-3, 610-4, and 610-5, and burst 605-3 may include ADU 605-6. In some cases, a PDU set may include a plurality of IP packets that correspond to a unit of information for the application. For example, the PDU set may include a slice of a video frame (that can be FEC protected). In some cases, FEC may be used to add one or more parity symbols to a PDU set. In one example, a set of symbols that are considered together for FEC may be referred to as a block. A symbol is a unit of data to be used for the FEC. In one example, the symbol may have size T. A first K symbols of the symbol size T may be source symbols (e.g., systematic symbols) and a reminder of the symbols of the symbol size T may be the parity symbols (e.g., repair symbols).

In some cases, an OC sublayer may be integrated into an RLC layer. As shown in example 615, an OC sublayer 620 may be integrated into RLC layer 625 of a network protocol stack. PDCP packets belonging to a same PDU set may be identified as an OC block. The OC sublayer 620 may receive feedback from the PHY layer that indicates an OC symbol size, and may set an RLC SDU size to be equal to the OC symbol size. In some cases, PDCP packets may be segmented into RLC SDUs (e.g., OC symbols), may be OC encoded with a desired latency, and may be provided to the RLC, MAC, and PHY layers for over-the-air (OTA) transmission. Integrating the OC sublayer into the RLC layer rather than the MAC layer may allow for segmentation of the PDCP packets (e.g., since the MAC layer does not have segmentation functionality), may allow for more flexibility to perform OC on specific radio bearers having certain quality of service requirements, and/or may allow for more efficient traffic-specific operations (e.g., since MAC SDUs may have packets multiplexed from different radio bearers). Similarly, integrating the OC sublayer into the RLC layer rather than the PHY layer may enable segmentation functionality (e.g., since the PHY layer does not have segmentation functionality), may enable additional PDCP PDUs to be added as OC parity symbols, and may allow for DU-level processing rather than CU-level processing (which may be dynamically adapted based on channel conditions).

As indicated above, FIG. 6 is provided as an example. Other examples may differ from what is described with regard to FIG. 6.

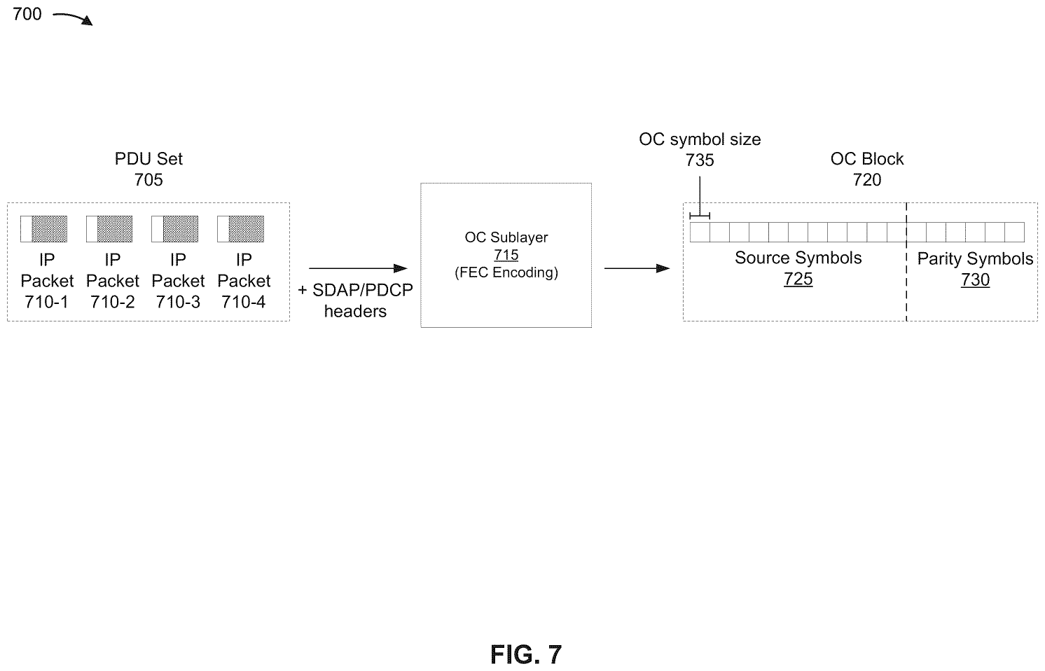

FIG. 7 is a diagram illustrating an example 700 of outer coding, in accordance with the present disclosure.

In some cases, an FEC may be applied to an individual PDCP PDU. In some other cases, an FEC may be applied to multiple PDCP PDUs, such as a PDU set or a burst. This may allow for increased granularity for FEC protection and may improve a probability of recovering a PDU set (e.g., in the case of a transmission error). A PDU set 705 may include a plurality of IP packets 710 (such as IP packet 710-1, IP packet 710-2, IP packet 710-3, and IP packet 710-4). An OC sublayer 715 configured to perform FEC encoding may receive an input that includes the PDU set 705 and at least one of SDAP or PDCP header information. The OC sublayer 715 may generate OC block 720 based at least in part on the PDU set 705 and the header information. The OC block 720 may include one or more source symbols 725 and one or more parity symbols 730. The one or more source symbols 725 and/or the one or more parity symbols 730 may have an OC symbol size 735. In some cases, a transmitting device (e.g., a network node) may transmit the OC block 720 to a receiving device (e.g., a UE). However, the transmitting device may not be configured with information that enables the transmitting device to construct the OC block 720 from the multiple PDCP packets. For example, the transmitting device may not be configured with mapping rules that enable the transmitting device to map the IP packets 710 to the OC symbols (e.g., the source symbols 725 and the parity symbols 730). Additionally, the transmitting device and/or the receiving device may not be configured to align a PDCP packet size with the OC symbol size 735. For example, the OC symbol size 735 may be determined by a RAN, whereas the PDCP packet size may be determined by an application layer. In one example, the PDCP packet size may be based at least in part on a size of the IP packets 710 and a size of the SDAP or PDCP headers. In some cases, the IP packets 710 included in the PDU set 705 may have different sizes, whereas each OC symbol may have the same OC symbol size 735. This may result in the IP packets 710 having a different size than the source symbols 725 and the parity symbols 730. The transmitting device and the receiving device may not be configured with information that enables the transmitting device and the receiving device to generate OC symbols that are aligned with the PDCP packet size. This may result in transmission errors that may require HARQ retransmissions, thereby increasing latency and power consumption at the transmitting device and the receiving device.

As indicated above, FIG. 7 is provided as an example. Other examples may differ from what is described with regard to FIG. 7.

FIG. 8 is a diagram illustrating an example 800 of an outer coding block assembly with outer coding source symbol segmentation, in accordance with the present disclosure. A transmitting device 805 may communicate with a receiving device 810. The transmitting device 805 may be any device that is configured to transmit data (and may also be configured to receive data), and the receiving device 810 may be any device that is configured to receive data (and may also be configured to transmit data). The transmitting device 805 may be a network node (such as the network node 110) or may be a UE (such as the UE 120). Additionally, the receiving device 810 may be a network node or a UE. In one example, the transmitting device 805 may be the network node 110 and the receiving device 810 may be the UE 120.

As shown by reference number 815, the transmitting device 805 may obtain a plurality of PDCP packets. The plurality of packets may be a plurality of PDCP PDUs. In some aspects, the plurality of PDCP packets may be a PDU set or multiple PDU sets.

As shown by reference number 820, the transmitting device 805 may generate an outer coding block. As shown by reference number 825, the transmitting device 805 may segment the outer coding block or a plurality of PDCP symbols. As shown in FIG. 8, operations associated with reference number 820 may be performed before operations associated with reference number 825 or may be performed after operations associated with reference number 825.

In a first example, the transmitting device 805 may generate the outer coding block prior to segmenting the outer coding block into the plurality of outer coding symbols. For example, in a first operation, the transmitting device 805 may generate the outer coding block based at least in part on assembling the plurality of PDCP packets into the outer coding block. In a second operation, the transmitting device 805 may segment the outer coding block into the plurality of outer coding symbols based at least in part on an outer coding symbol size. In some aspects, the transmitting device 805 may obtain an indication of the outer coding symbol size from a PHY layer function. In this first example, a PDCP boundary may not be aligned with an outer coding symbol boundary. This may allow for a straightforward design, may allow for any outer coding symbol size to be adopted (regardless of the PDCP packet size), and may minimize a required number of outer coding symbols. In some aspects, zero padding may be assumed for a last outer coding symbol of the outer coding block. This may align the outer coding symbol size with the PDCP packet size.

In a second example, the transmitting device 805 may perform outer coding segmentation prior to generating the outer coding block. For example, in a first operation, the transmitting device 805 may segment each PDCP packet of the plurality of PDCP packets into outer coding symbols based at least in part on an outer coding symbol size. In some aspects, the transmitting device 805 may obtain an indication of the outer coding symbol size from a PHY layer function. In a second operation, the transmitting device 805 may generate the outer coding block based at least in part on assembling the plurality of outer coding symbols. In this second example, there may be no segmentation across PDCP packets. However, there may be segmentation for each individual PDCP packet of the plurality of PDCP packets. This may enable pipelined PDCP PDUs and/or may enable parallel stack and outer coding processing. In some aspects, zero padding may be assumed for a last outer coding symbol of the PDCP packet. This may align the outer coding symbol size with the PDCP packet size.

As shown by reference number 830, the transmitting device 805 may apply FEC to the outer coding block. In the first example, the transmitting device 805 may apply the FEC encoding to the outer coding block after generating the outer coding block and after segmenting the outer coding block into the plurality of outer coding symbols. In the second example, the transmitting device 805 may apply the FEC encoding to the outer coding block after segmenting each PDCP packet of the plurality of PDCP packets into the outer coding symbols and after generating the outer coding block using the plurality of outer coding symbols.

As shown by reference number 835, the transmitting device 805 may transmit the plurality of outer coding symbols. For example, the transmitting device 805 may transmit the outer coding block that includes the plurality of outer coding symbols based at least in part on applying the FEC to the outer coding block.

As indicated above, FIG. 8 is provided as an example. Other examples may differ from what is described with regard to FIG. 8.

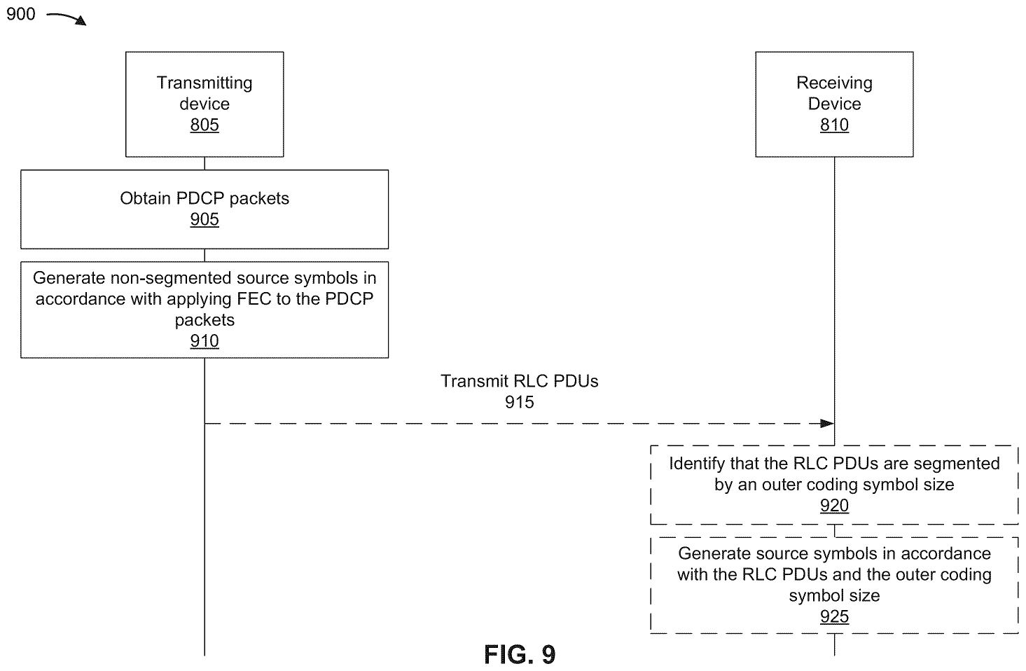

FIG. 9 is a diagram illustrating an example 900 of an outer coding block assembly without outer coding source symbol segmentation, in accordance with the present disclosure.

As shown by reference number 905, the transmitting device 805 may obtain a plurality of PDCP packets. The plurality of packets may be a plurality of PDCP PDUs. In some aspects, the plurality of PDCP packets may be a PDU set or multiple PDU sets.

As shown by reference number 910, the transmitting device 805 may generate a plurality of source symbols. The plurality of source symbols may be a plurality of non-segmented source symbols. The transmitting device 805 may generate the plurality of source symbols based at least in part on applying FEC to the PDCP packets. Using outer coding FEC, the original PDCP PDUs may become the outer coding source symbols. For example, the original PDCP PDUs may not be segmented and transmitted. Instead, the outer coding encoder and decoder may assume that the PDCP PDUs are segmented into source symbols. Thus, the source symbols may be equal to the PDCP PDUs.

In one example, for source symbols, the RLC PDUs may be transmitted without outer coding symbol segmentation. For parity symbols, an outer coding decoder may assume that the PDCP PDUs are segmented into a plurality of source symbols based at least in part on an outer coding symbol size, and may generate the outer coding parity symbols based at least in part on the plurality of source symbols. In some aspects, the transmitting device 805 (e.g., the outer coding decoder) may obtain an indication of the outer coding symbol size from a PHY layer.

As shown by reference number 915, the transmitting device 805 may transmit, and the receiving device 810 may receive, a plurality of RLC PDUs corresponding to the plurality of source symbols. The plurality of RLC PDUs may be transmitted without outer coding symbol segmentation. This may save overhead associated with RLC and outer coding headers caused by outer coding symbol segmentation.

As shown by reference number 920, the receiving device 810 may identify that the RLC PDUs are segmented by an outer coding symbol size. In some aspects, the receiving device 810 (e.g., an outer coding encoder) may obtain an indication of the outer coding symbol size from an outer coding post-header.

As shown by reference number 925, the receiving device 810 may generate a plurality of source symbols based at least in part on the RLC PDUs and the outer coding symbol size. In one example, for source symbols, an outer coding encoder may assume that the delivered RLC PDUs are segmented by the outer coding symbol size, and may generate (e.g., recover) the plurality of source symbols based at least in part on the outer coding symbol size. For parity symbols, the outer coding encoder may receive the additional parity symbols and may recover the source symbols based at least in part on the plurality of parity symbols.

In some aspects, by generating the plurality of outer coding source symbols without segmenting the PDCP PDUs, pipelined PDCP PDU and parallel stack and outer coding processing may be supported. Additionally, there may be no additional overhead associated with RLC and outer coding headers, and the outer coding source symbols may be compatible with legacy systems and legacy source symbols.

In some aspects, the outer coding source symbols may be associated with a symbol index. The transmitting device 805 may indicate a first outer coding symbol index in an outer coding post-header. The receiving device 810 may identify the outer coding symbol index based at least in part on the symbol index indicated in the outer coding post-header and a segmented outer coding symbol order. For example, the receiving device 810 may obtain the indication of the first outer coding symbol index, and may calculate each of the segmented outer coding symbol indexes based at least in part on the first outer coding symbol index.

In some aspects, the transmitting device 805 and the receiving device 810 may identify (e.g., assume) a zero padding for a last outer coding symbol of the plurality of outer coding symbols. This may align a size of the outer coding symbols with a size of the PDCP packets.

As indicated above, FIG. 9 is provided as an example. Other examples may differ from what is described with regard to FIG. 9.

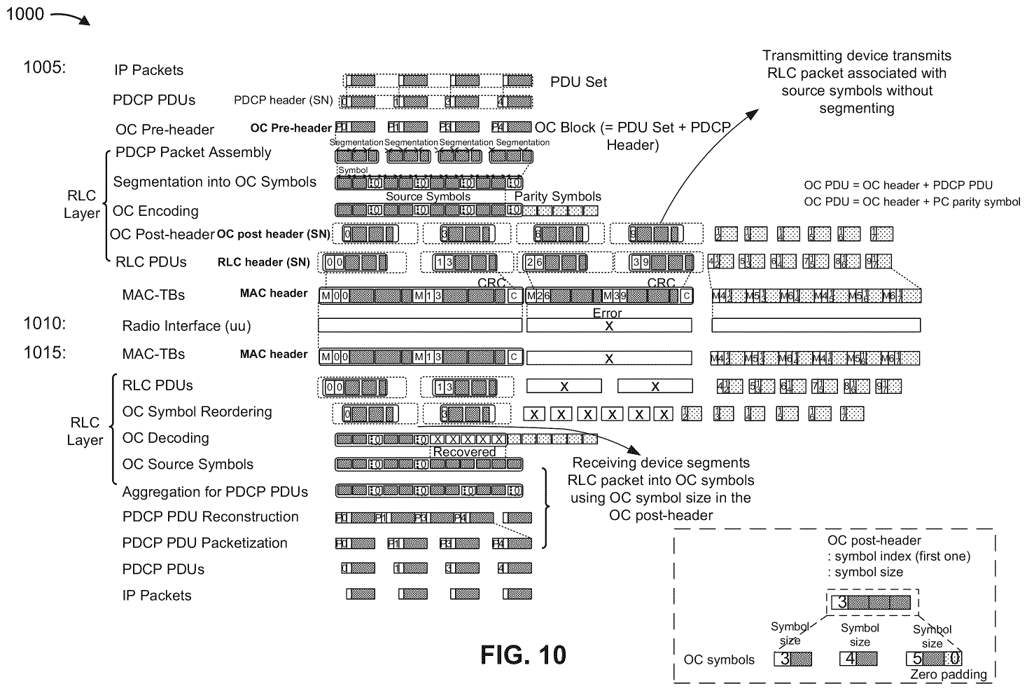

FIG. 10 is a diagram illustrating an example 1000 of an outer coding block assembly, in accordance with the present disclosure.

A transmitting device (such as the transmitting device 805) may generate a plurality of outer coding source symbols based at least in part on a plurality of PDCP PDUs without segmenting the outer coding source symbols or the PDCP PDUs. As shown by reference number 1005, the transmitting device may obtain a plurality of IP packets. The transmitting device may generate a plurality of PDCP PDUs based at least in part on the plurality of IP packets. The transmitting device may generate an outer coding pre-header for each PDCP PDU of the plurality of PDCP PDUs. At an RLC layer, the transmitting device may segment the PDCP PDUs (with the outer coding pre-header) into a plurality of outer coding symbols, may generate a plurality of outer coding source symbols based at least in part on the outer coding symbols, may perform outer coding encoding on the plurality of outer coding source symbols, may generate an outer coding post-header for the plurality of outer coding source symbols, and may generate a plurality of RLC PDUs based at least in part on the plurality of outer coding source symbols with the outer coding post-headers. In some examples, an outer coding post-header size may be based at least in part on (e.g., may be equal to) an outer coding header size plus a PDCP PDU size. For example, in an outer coding sublayer, the outer coding PDU source symbols may be defined using a PDCP PDU with an outer coding header. Additionally, or alternatively, the outer coding post-header size may be based at least in part on (e.g., may be equal to) the outer coding header size plus an outer coding parity symbol size. For example, in an outer coding sublayer, the outer coding PDU source symbols may be defined using a parity symbol with an outer coding header. The transmitting device may generate a plurality of MAC transport blocks (TBs) based at least in part on the plurality of RLC PDUs. As shown in FIG. 10, the transmitting device may transmit the RLC packet associated with the plurality of outer coding source symbols without segmenting in accordance with the outer coding symbol size. As shown by reference number 1010, the transmitting device may transmit, and a receiving device (such as the receiving device 810) may receive, the plurality of MAC TBs over a radio interface. As shown by reference number 1015, at the RLC layer, the receiving device may generate a plurality of RLC PDUs based at least in part on the plurality of MAC TBs, may perform outer coding symbol re-ordering, may perform outer coding symbol decoding, may generate a plurality of outer coding source symbols based at least in part on the outer symbol decoding, and may perform aggregation for a plurality of PDCP PDUs. Additionally, the receiving device may perform PDCP PDU reconstruction, may perform PDCP PDU packetization, may generate a plurality of PDCP PDUs based at least in part on the PDCP PDU packetization, and may generate a plurality of IP packets based at least in part on the PDCP PDUs. As shown in FIG. 10, the receiving device may segment the RLC packet into a plurality of outer coding source symbols based at least in part on an outer coding symbol size included in an outer coding post-header.

As indicated above, FIG. 10 is provided as an example. Other examples may differ from what is described with regard to FIG. 10.

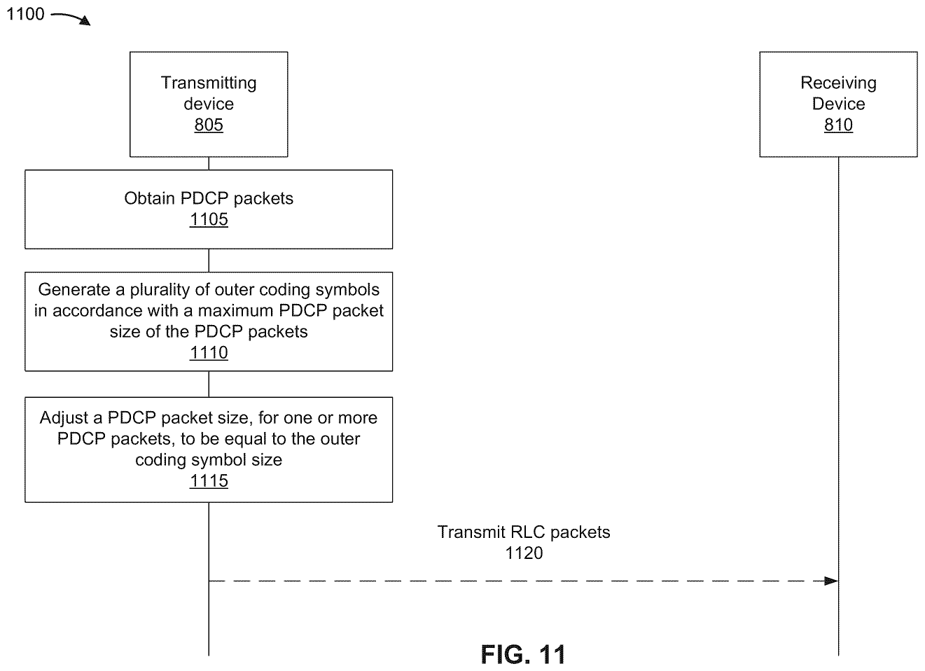

FIG. 11 is a diagram illustrating an example 1100 of adjusting an outer coding symbol size, in accordance with the present disclosure.

As shown by reference number 1105, the transmitting device 805 may obtain a plurality of PDCP packets. The plurality of packets may be a plurality of PDCP PDUs. In some aspects, the plurality of PDCP packets may be a PDU set or multiple PDU sets.

As shown by reference number 1110, the transmitting device 805 may generate a plurality of outer coding symbols in accordance with the plurality of PDCP packets. For example, the transmitting device 805 may identify a maximum PDCP packet size of the plurality of PDCP packets, and may generate a plurality of outer coding symbols in accordance with the maximum PDCP packet size. As described herein, each outer coding symbol included in an outer coding block may have the same size. Thus, generating the plurality of outer coding symbols may include generating a plurality of outer coding symbols having a same size that is equal to the maximum PDCP packet size. In some aspects, zero padding may be assumed for smaller PDCP packets (e.g., PDCP packets not having the maximum PDCP packet size) to make the outer coding symbol size to be aligned with the maximum PDCP packet size.

As shown by reference number 1115, the transmitting device 805 may adjust a PDCP packet size to be equal to the outer coding symbol size. For example, the transmitting device 805 may identify one or more PDCP packets having a PDCP packet size that is not equal to the outer coding symbol size, and may adjust a size of the one or more PDCP packets to be equal to the outer coding symbol size. In some aspects, the one or more PDCP packets may be adjusted to the outer coding symbol size during an outer coding decoding or encoding process. Additionally, concatenation and segmentation may not be required for all of the outer coding symbols. This may allow for pipelined PDCP PDUs and may allow for improved parallel stack and outer coring processing.

As shown by reference number 1120, the transmitting device 805 may transmit a plurality of RLC packets. For example, the transmitting device 805 may transmit a single RLC packet for each PDCP packet of the plurality of PDCP packets.

As indicated above, FIG. 11 is provided as an example. Other examples may differ from what is described with regard to FIG. 11.

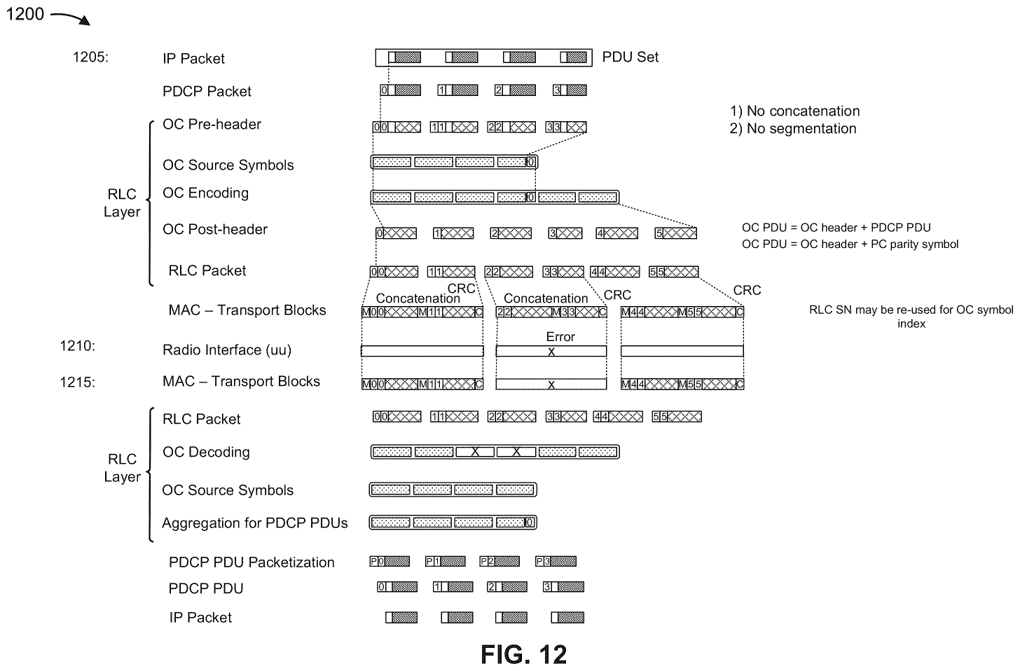

FIG. 12 is a diagram illustrating an example 1200 of radio link control packet transmission using maximum packet data convergence protocol packet size, in accordance with the present disclosure. As shown by reference number 1205, a transmitting device (such as the transmitting device 805) may obtain a plurality of IP packets. The plurality of IP packets may be included in a PDU set. The plurality of IP packets may be based at least in part on a plurality of transmission control protocol (TCP) or user datagram protocol (UDP) information. The TCP or UDP information may be based at least in part on real-time transport (RTP) or secure RTP (SRTP) information. The transmitting device may generate an outer coding pre-header for the plurality of PDCP packets, may generate a plurality of outer coding source symbols based at least in part on the plurality of PDCP packets and the outer coding pre-header, may perform outer coding encoding for the plurality of outer coding source symbols, and may generate an outer coding post-header based at least in part on performing the outer coding encoding for the plurality of outer coding source symbols. The transmitting device may generate a plurality of RLC packets based at least in part on performing the outer coding encoding and generating the outer coding post-header, and may generate a plurality of MAC TBs based at least in part on the plurality of RLC packets. In some examples, an outer coding post-header size may be based at least in part on (e.g., may be equal to) an outer coding header size plus a PDCP PDU size. For example, in an outer coding sublayer, the outer coding PDU source symbols may be defined using a PDCP PDU with an outer coding header. Additionally, or alternatively, the outer coding post-header size may be based at least in part on (e.g., may be equal to) the outer coding header size plus an outer coding parity symbol size. For example, in an outer coding sublayer, the outer coding PDU source symbols may be defined using a parity symbol with an outer coding header. As shown by reference number 1210, the transmitting device may transmit the plurality of MAC TBs over a radio interface. As shown by reference number 1215, a receiving device (such as the receiving device 810) may receive the plurality of MAC TBs, may generate a plurality of RLC packets based at least in part on the plurality of MAC TBs, may perform outer coding decoding for the plurality of RLC packets, may generate a plurality of outer coding source symbols based at least in part on performing the outer coding encoding for the plurality of RLC packets, and may perform aggregation for a plurality of PDCP PDUs that are based at least in part on the plurality of RLC packets. The receiving device may perform PDCP PDU packetization based at least in part on performing aggregating the plurality of PDCP PDUs, may generate a plurality of PDCP PDUs based at least in part on performing the PDCP PDU packetization, and may generate a plurality of IP packets that are based at least in part on the plurality of PDCP PDUs.

As indicated above, FIG. 12 is provided as an example. Other examples may differ from what is described with regard to FIG. 12.

As described herein, in Option 1 (as described in the first example of FIG. 8), a transmitting device may perform outer coding block assembly prior to outer coding symbol segmentation. In Option 2 (as described in the second example of FIG. 8), the transmitting device may perform outer coding symbol segmentation prior to performing outer coding block assembly. In Option 3 (as described in FIG. 9), the transmitting device may perform outer coding block assembly without performing outer coding source symbol segmentation. In Option 4 (as described in FIG. 11), the transmitting device may generate outer coding symbols in accordance with a maximum PDCP PDU size. Comparisons of the first option, second option, third option, and fourth option are shown in Table 1.

TABLE 1

| | Option 1 | Option 2 | Option 3 | Option 4 |
|---|---|---|---|---|
| Impact to 5G | High | Medium | Low | Low |
| stack | (aggregation | (only | (No | (No |
| processing | across PDCP | segmentation) | segmentation | segmentation |
| | packets, | | or aggregation) | or aggregation) |
| | segmentation | | | |
| | in a PDCP | | | |
| | packet) | | | |
| PDCP packet | Yes | No | No | No |
| aggregation | | | | |
| (across PDCP | | | | |
| packets) | | | | |
| PDCP packet | Yes | Yes | Yes | No |
| segmentation | | | | |
| (in a single | | | | |
| PDCP packet) | | | | |
| Pipelined | No | Yes | Yes | Yes |
| PDCP PDU | | | | |
| transmission | | | | |
| Pipelined | No | Yes | Yes | Yes |
| PDCP PDU | | | | |
| reception | | | | |
| Parallel stack | No | Yes | Yes | Yes |
| and OC | | | | |
| processing | | | | |
| Number of | High | High | High | Low |
| FEC symbols | (e.g., | (e.g., | (e.g., | (34) |
| (example) | 100) | 100-134) | 100-134) | |
| FEC symbol | High | Medium | Medium | Low |
| size | (any optimal | (symbol size < | (symbol size < | (set to PDCP |
| optimization | symbol size) | PDCP packet | PDCP packet | packet size) |
| | | size) | size) | |
| FEC recovery | High | High | High | Low |
| performance | | | | |
| FEC + RLC | High | Medium | Low | Low |
| header | (needs to | | | |
| overhead | indicate the | | | |
| | PDCP packet | | | |
| | boundary) | | | |

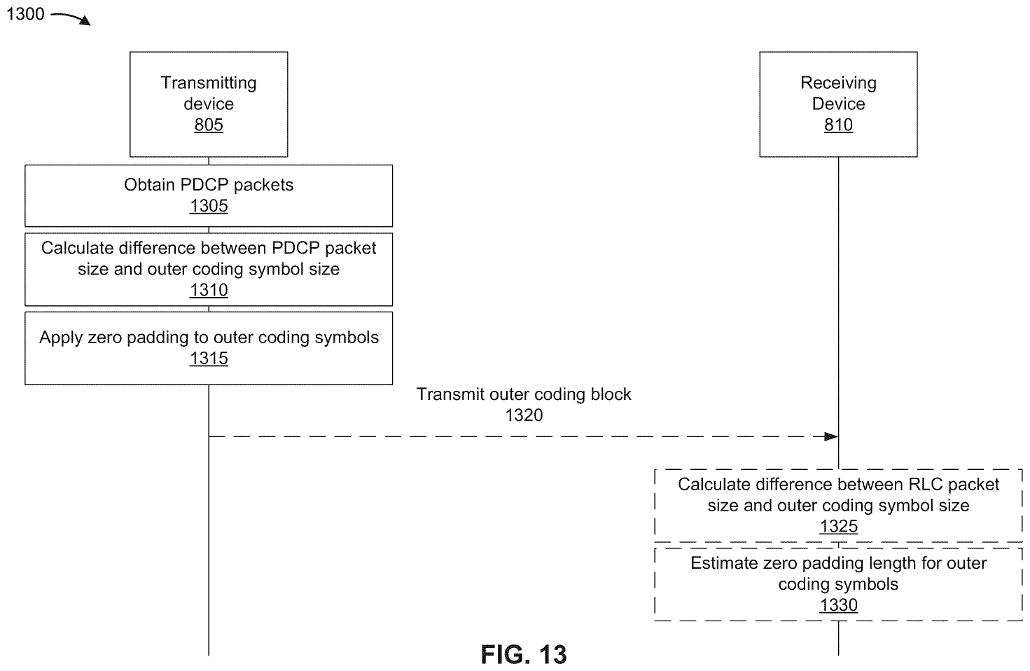

FIG. 13 is a diagram illustrating an example 1300 of zero padding for segmented outer coding symbols, in accordance with the present disclosure. In some cases, a PDCP packet size and an outer coding symbol size may not be aligned with each other (e.g., may not be the same size). For example, the outer coding symbol size may be determined by a RAN, and the PDCP PDU size may be determined by an application layer (and may be equal to an IP packet size plus an SDAP/PDCP header size). In this case, a transmitting device (such as the transmitting device 805) and a receiving device (such as the receiving device 810) may identify a zero padding to align the outer coding symbol size with the PDCP PDU size.

As shown by reference number 1305, the transmitting device 805 may obtain a plurality of PDCP packets. The plurality of packets may be a plurality of PDCP PDUs. In some aspects, the plurality of PDCP packets may be a PDU set or multiple PDU sets.

As shown by reference number 1310, the transmitting device 805 may calculate a difference between a PDCP packet size and an outer coding symbol size. For example, the transmitting device 805 may subtract the outer coding symbol size from the PDCP packet size.

As shown by reference number 1315, the transmitting device 805 may apply a zero padding to the plurality of outer coding symbols. The transmitting device 805 may apply the zero padding based at least in part on calculating the difference between the PDCP packet size and the outer coding symbol size. For source symbols, the transmitting device 805 may identify a zero padding to be applied at an end of each outer coding symbol segmentation. The transmitting device 805 may determine that the zero padding length is to be equal to an outer coding symbol size minus a size of a last segmented RLC SDU. For example, zero padding length=(OC symbol size)−(size of last segmented RLC SDU). The zero padding may not be transmitted over the air. Instead, an OC sublayer may add the zero padding when performing FEC encoding or decoding. This may conserve radio resources associated with the zero padding.

As shown by reference number 1320, the transmitting device 805 may transmit, and the receiving device 810 may receive, an outer coding block that includes the plurality of outer coding symbols. As described above, the transmitting device 805 may transmit the plurality of outer coding symbols but may not transmit the zero padding symbols.

As shown by reference number 1325, the receiving device 810 may calculate a difference between the packet size and the outer coding symbol size. For example, the receiving device 810 may subtract the outer coding symbol size from the PDCP packet size.

As shown by reference number 1330, the receiving device 810 may estimate a zero padding length for the plurality of outer coding symbols. In some aspects, an OC sublayer may estimate the zero padding length based at least in part on the symbol size and the received packet size. For example, the receiving device 810 may determine that the zero padding length is to be equal to an OC symbol size minus a modulo operation between the RLC PDU size and the OC symbol size. For example, zero padding length=(OC symbol size)−((RLC PDU size) mod (OC symbol size)).

As indicated above, FIG. 13 is provided as an example. Other examples may differ from what is described with regard to FIG. 13.

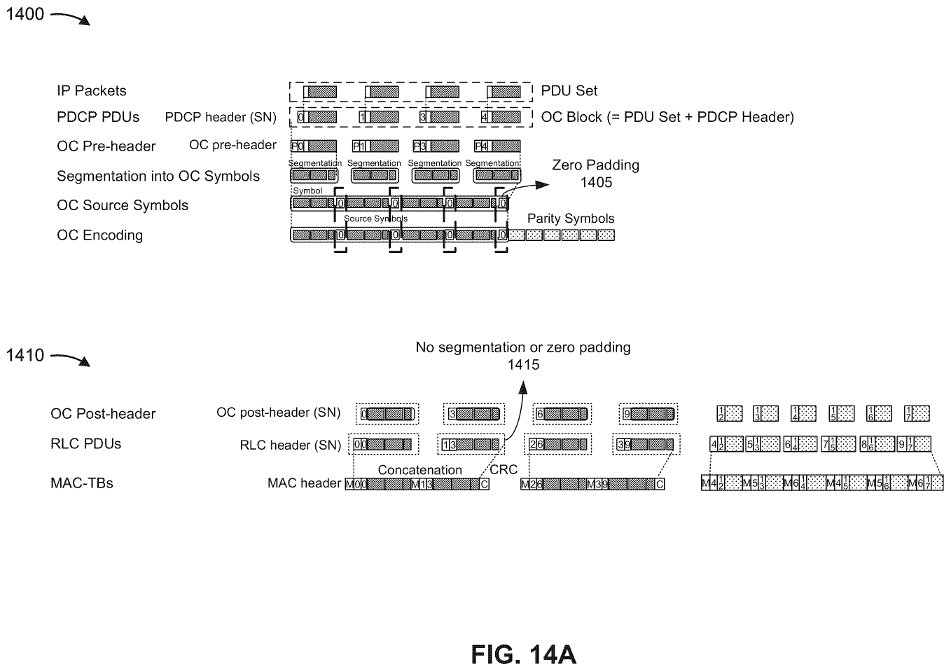

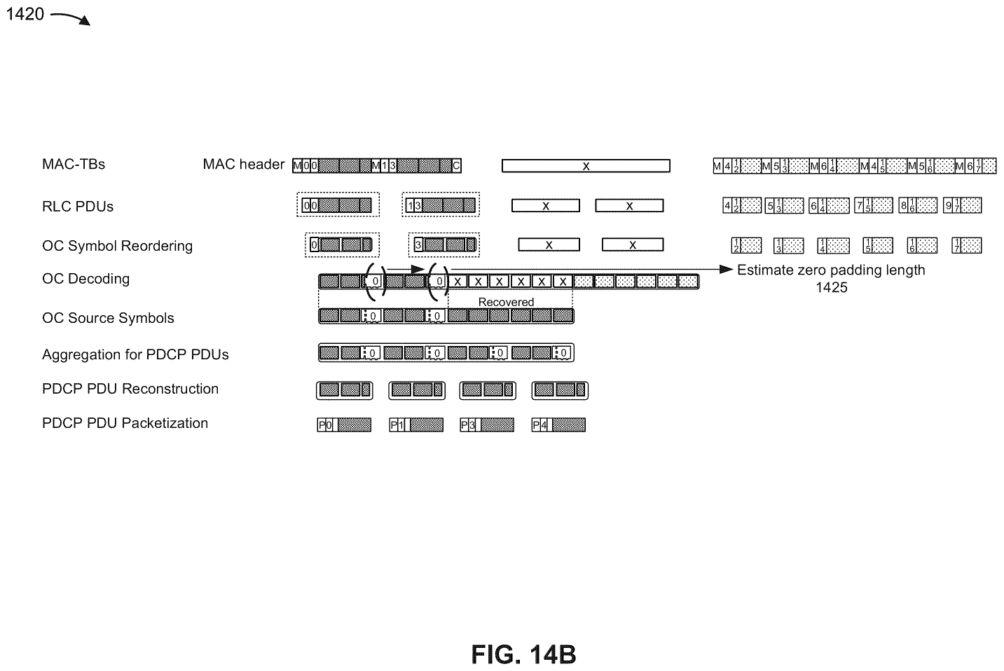

FIGS. 14A-14B are diagrams illustrating examples of zero padding performed by a transmitting device and a receiving device, in accordance with the present disclosure.

As shown in FIG. 14A and example 1400, a transmitting device (such as the transmitting device 805) may generate a plurality of source symbols. As shown by reference number 1405, a zero padding (e.g., one or more zero padding signals) may be encoded at an end of each outer coding symbol segmentation. In this example, PDCP PDUs may not be divided by the outer coding symbol size, and the size of the last segmented RLC PDU may not be the same as the outer coding symbol size. The transmitting device may assume one or more zero padding bits for the last RLC PDU in a PDCP PDU. In some aspects, the zero padding length may be equal to the outer coding symbol size minus the size of the last segmented RLC SDU. As shown by reference number 1410, the transmitting device may transmit a plurality of RLC PDUs. As shown by reference number 1415, the RLC PDUs may not include the zero padding. The zero padding symbols may not be transmitted over the air, for example, to conserve radio resources.

As shown in FIG. 14B and example 1420, a receiving device (e.g., receiving device 810) may receive a plurality of RLC PDUs and may perform outer coding symbol reordering. The receiving device (e.g., a decoder associated with the receiving device) may decode the outer coding symbols to obtain a plurality of outer coding source symbols. At the RLC layer, an RLC SDU may be reassembled if a PDCP packet is segmented into multiple RLC SDUs. At the outer coding decoder, the RLC SDU may be segmented in accordance with an outer coding symbol size. In some aspects, the receiving device may assume one or more zero padding bits for a last outer coding symbol in an RLC PDU. As shown by reference number 1425, an outer coding sublayer may estimate a zero padding length based at least in part on the outer coding symbol size and/or a reassembled RLC PDU size. In some aspects, the zero padding length may be equal to the outer coding symbol size minus a modulo operation between the RLC PDU size and the outer coding symbol size. The outer coding symbol size may be indicated in an outer coding post-header, and the RLC PDU size may be indicated in a MAC header. In some aspects, the received RLC PDUs may be reconstructed to PDCP PDUs with an RLC header. Additionally, the recovered symbols may be reconstructed to PDCP PDUs in accordance with a PDCP length indicator included in an outer coding pre-header.

As indicated above, FIGS. 14A-14B are provided as examples. Other examples may differ from what is described with regard to FIGS. 14A-14B.

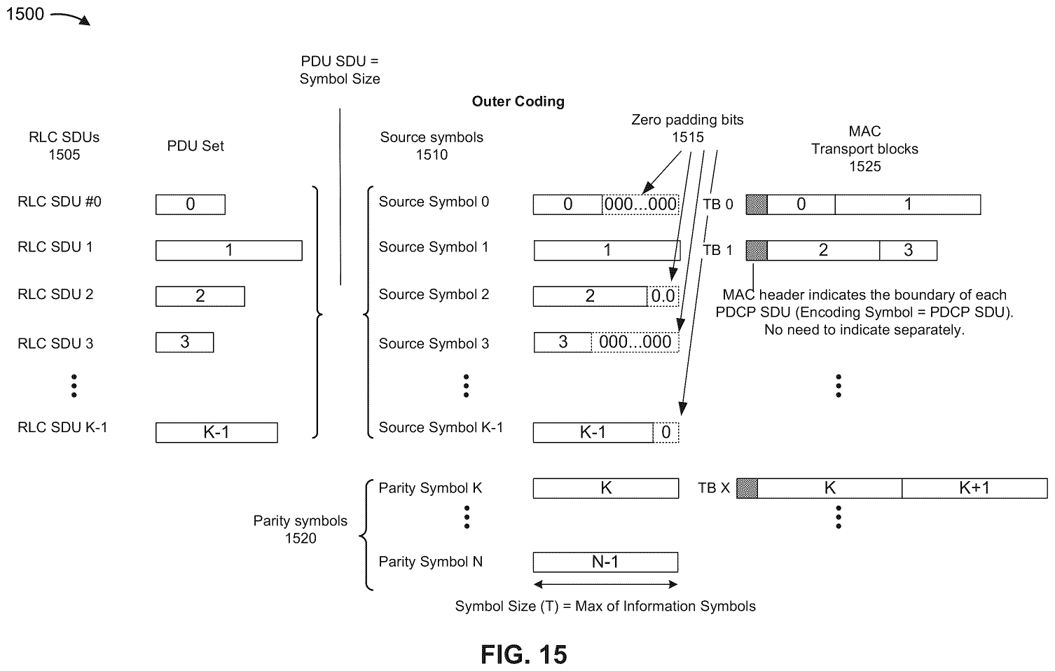

FIG. 15 is a diagram illustrating an example 1500 of zero padding for outer coding symbols, in accordance with the present disclosure. A transmitting device (such as transmitting device 805) may obtain a plurality of RLC SDUs 1505. For example, the transmitting device may obtain RLC SDU 0, RLC SDU 1, RLC SDU 2, RLC SDU 3, and RLC SDU K-1. The transmitting device may generate a plurality of source symbols 1510 based at least in part on an outer coding. For example, the transmitting device may generate source symbol 0 (based at least in part on RLC SDU 0), source symbol 1 (based at least in part on RLC SDU 1), source symbol 2 (based at least in part on RLC SDU 2), source symbol 3 (based at least in part on RLC SDU 3), and source symbol K (based at least in part on RLC SDU K). The transmitting device may generate one or more zero padding bits 1515 to be added to the source symbols 1510. For example, the zero padding bits 1515 may align the size of the source symbols with a symbol size (T) (e.g., a maximum of information symbols). The zero padding bits may not be delivered over the air. Zero padding may be assumed only for FEC encoding and decoding. The transmitting device may generate one or more parity symbols 1520, such as parity symbol K and parity symbol N. The transmitting device may generate the parity symbols 1520 while the RAN is transmitting systematic symbols (e.g., source symbols). The transmitting device may generate one or more transport blocks 1525. A MAC header may indicate a boundary of each PDCP SDU, where an encoding symbol is equal to the PDCP SDU. For the systematic symbols (source symbols), the transport blocks may be transmitted in accordance with legacy transmissions. The parity symbols may be transmitted in order to improve reliability of the source symbols being successfully received by a receiving device.

In some aspects, the transmitting device may not indicate the outer coding symbol size for each outer coding block. For example, the transmitting device may only indicate the outer coding symbol size a single time. In this case, the receiving device may use the indicated symbol size for each outer coding block, and may not update the outer coding symbol size until the receiving device receives additional signaling (for example, semi-static signaling) from the transmitting device. For example, the receiving device may use the indicated outer coding symbol size for all outer coding symbols until the receiving device receives semi-static signaling indicating an update to the outer coding symbol size. Thereafter, the receiving device may use the updated outer coding symbol size for the outer coding symbols and/or for subsequent outer coding symbols. This may reduce signaling overhead for indicating and updating the symbol size.

In some cases, the outer coding symbol size may be set to the maximum PDU size of the PDU set. However, this can result in a server (for example, the transmitting device) generating PDUs having a large PDU size, such as a larger PDU size than is permitted for outer coding encoding. In some aspects, the server and a network node may negotiate the maximum PDU size that is permitted for the PDUs. For example, the network node may transmit, and the transmitting device may receive, an indication of the maximum PDU size that is permitted for the PDCP PDUs. The transmitting device may refrain from transmitting PDUs having a PDU size that is larger than the maximum PDU size indicated by the network node. In some aspects, the transmitting device may transmit information to the network node that assists the network node with determining or updating the maximum PDU size.

As indicated above, FIG. 15 is provided as an example. Other examples may differ from what is described with regard to FIG. 15.

FIG. 16 is a diagram illustrating an example process 1600 performed, for example, at a transmitting device or an apparatus of a transmitting device, in accordance with the present disclosure. Example process 1600 is an example where the apparatus or the transmitting device (e.g., transmitting device 805) performs operations associated with network coding for packet data convergence protocol communications.

As shown in FIG. 16, in some aspects, process 1600 may include obtaining a plurality of PDCP packets (block 1610). For example, the transmitting device (e.g., using reception component 2102 and/or communication manager 2106, depicted in FIG. 2100) may obtain a plurality of PDCP packets, as described above.

As further shown in FIG. 16, in some aspects, process 1600 may include generating a plurality of source symbols in accordance with applying a forward error correction encoding to the plurality of PDCP packets, wherein the plurality of source symbols are non-segmented outer coding source symbols (block 1620). For example, the transmitting device (e.g., using communication manager 2106, depicted in FIG. 2100) may generate a plurality of source symbols in accordance with applying a forward error correction encoding to the plurality of PDCP packets, wherein the plurality of source symbols are non-segmented outer coding source symbols, as described above.

As further shown in FIG. 16, in some aspects, process 1600 may include transmitting the plurality of source symbols (block 1630). For example, the transmitting device (e.g., using transmission component 2104 and/or communication manager 2106, depicted in FIG. 2100) may transmit the plurality of source symbols, as described above.

Process 1600 may include additional aspects, such as any single aspect or any combination of aspects described below and/or in connection with one or more other processes described elsewhere herein.

In a first aspect, process 1600 includes generating a plurality of outer coding parity symbols in accordance with the plurality of source symbols.

In a second aspect, alone or in combination with the first aspect, generating the plurality of outer coding parity symbols comprises generating the plurality of outer coding parity symbols in accordance with the plurality of source symbols and an outer coding symbol size.

In a third aspect, alone or in combination with one or more of the first and second aspects, process 1600 includes obtaining, from a physical layer, an indication of the outer coding symbol size, wherein the plurality of outer coding parity symbols are based at least in part on the outer coding symbol size.

In a fourth aspect, alone or in combination with one or more of the first through third aspects, a source symbol size associated with the plurality of source symbols is smaller than a PDCP packet size associated with the plurality of PDCP packets.

In a fifth aspect, alone or in combination with one or more of the first through fourth aspects, process 1600 includes indicating a source symbol index for a first source symbol of the plurality of source symbols.

In a sixth aspect, alone or in combination with one or more of the first through fifth aspects, process 1600 includes refraining from indicating a source symbol index for a remainder of the plurality of source symbols subsequent to the first source symbol.

In a seventh aspect, alone or in combination with one or more of the first through sixth aspects, process 1600 includes identifying a zero padding length for a last outer coding symbol associated with a PDCP packet of the plurality of PDCP packets to align a size of the last outer coding symbol with a size of the PDCP packet.

In an eighth aspect, alone or in combination with one or more of the first through seventh aspects, identifying the zero padding length for the last outer coding symbol comprises aligning the size of the last outer coding symbol with the size of the PDCP packet based at least in part on the zero padding length.

In a ninth aspect, alone or in combination with one or more of the first through eighth aspects, the plurality of PDCP packets are a plurality of PDCP protocol data units.

In a tenth aspect, alone or in combination with one or more of the first through ninth aspects, the transmitting device is a network node.

In an eleventh aspect, alone or in combination with one or more of the first through tenth aspects, the transmitting device is a UE.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a transmitting device or an apparatus of a transmitting device, in accordance with the present disclosure. Example process 1700 is an example where the apparatus or the transmitting device (e.g., transmitting device 805) performs operations associated with network coding for packet data convergence protocol communications.

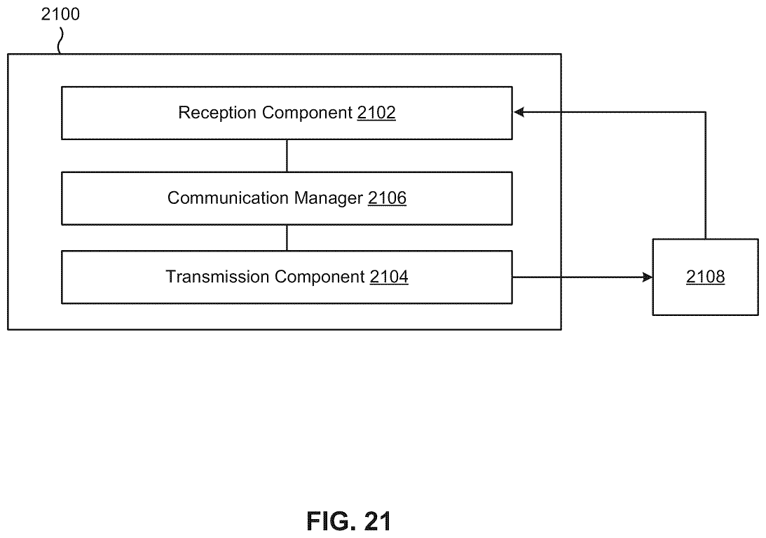

As shown in FIG. 17, in some aspects, process 1700 may include obtaining a plurality of PDCP packets (block 1710). For example, the transmitting device (e.g., using reception component 2102 and/or communication manager 2106, depicted in FIG. 21) may obtain a plurality of PDCP packets, as described above.

As further shown in FIG. 17, in some aspects, process 1700 may include generating a plurality of outer coding symbols in accordance with a maximum PDCP packet size of the plurality of PDCP packets (block 1720). For example, the transmitting device (e.g., using communication manager 2106, depicted in FIG. 21) may generate a plurality of outer coding symbols in accordance with a maximum PDCP packet size of the plurality of PDCP packets, as described above.

As further shown in FIG. 17, in some aspects, process 1700 may include adjusting a PDCP packet size, for one or more PDCP packets not having the maximum PDCP packet size, to be equal to an outer coding symbol size of the plurality of outer coding symbols (block 1730). For example, the transmitting device (e.g., using communication manager 2106, depicted in FIG. 21) may adjust a PDCP packet size, for one or more PDCP packets not having the maximum PDCP packet size, to be equal to an outer coding symbol size of the plurality of outer coding symbols, as described above.

As further shown in FIG. 17, in some aspects, process 1700 may include transmitting the plurality of PDCP packets in accordance with adjusting the PDCP packet size (block 1740). For example, the transmitting device (e.g., using transmission component 2104, depicted in FIG. 21) may transmit the plurality of PDCP packets in accordance with adjusting the PDCP packet size, as described above.

Process 1700 may include additional aspects, such as any single aspect or any combination of aspects described below and/or in connection with one or more other processes described elsewhere herein.

In a first aspect, process 1700 includes transmitting a single radio link control layer packet corresponding to each PDCP packet of the plurality of PDCP packets.

In a second aspect, alone or in combination with the first aspect, transmitting the single radio link control layer packet comprises transmitting the single radio link control layer packet corresponding to each PDCP packet of the plurality of PDCP packets without performing a concatenation operation or a segmentation operation.

In a third aspect, alone or in combination with one or more of the first and second aspects, process 1700 includes applying forward error correction encoding to an outer coding block that includes the plurality of outer coding symbols.

In a fourth aspect, alone or in combination with one or more of the first through third aspects, process 1700 includes identifying one or more zero padding bits to be applied to a PDCP packet of the plurality of PDCP packets that does not have a size that is equal to the maximum PDCP packet size.

In a fifth aspect, alone or in combination with one or more of the first through fourth aspects, identifying the one or more zero padding bits to be applied to the PDCP packet comprises identifying one or more zero padding bits to be applied to the PDCP packet to align a size of the PDCP packet with the maximum PDCP packet size.

In a sixth aspect, alone or in combination with one or more of the first through fifth aspects, the plurality of PDCP packets are a plurality of PDCP protocol data units.

In a seventh aspect, alone or in combination with one or more of the first through sixth aspects, the transmitting device is a network node.

In an eighth aspect, alone or in combination with one or more of the first through seventh aspects, the transmitting device is a UE.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, at a transmitting device or an apparatus of a transmitting device, in accordance with the present disclosure. Example process 1800 is an example where the apparatus or the transmitting device (e.g., transmitting device 805) performs operations associated with network coding for packet data convergence protocol communications.

As shown in FIG. 18, in some aspects, process 1800 may include obtaining a plurality of PDCP packets (block 1810). For example, the transmitting device (e.g., using reception component 2102 and/or communication manager 2106, depicted in FIG. 21) may obtain a plurality of PDCP packets, as described above.

As further shown in FIG. 18, in some aspects, process 1800 may include applying, in accordance with a difference between a PDCP packet size associated with the plurality of PDCP packets and an outer coding symbol size associated with a plurality of outer coding symbols, a zero padding to the plurality of outer coding symbols (block 1820). For example, the transmitting device (e.g., using communication manager 2106, depicted in FIG. 21) may apply, in accordance with a difference between a PDCP packet size associated with the plurality of PDCP packets and an outer coding symbol size associated with a plurality of outer coding symbols, a zero padding to the plurality of outer coding symbols, as described above.

As further shown in FIG. 18, in some aspects, process 1800 may include transmitting the outer coding block in accordance with applying the zero padding to the plurality of outer coding symbols (block 1830). For example, the transmitting device (e.g., using transmission component 2104 and/or communication manager 2106, depicted in FIG. 21) may transmit the outer coding block in accordance with applying the zero padding to the plurality of outer coding symbols, as described above.

Process 1800 may include additional aspects, such as any single aspect or any combination of aspects described below and/or in connection with one or more other processes described elsewhere herein.

In a first aspect, applying the zero padding to the plurality of outer coding symbols comprises adding one or more zero padding bits to the plurality of outer coding symbols, and wherein transmitting the outer coding block comprises refraining from transmitting the one or more zero padding bits associated with the plurality of outer coding symbols.

In a second aspect, alone or in combination with the first aspect, process 1800 includes obtaining an indication of the outer coding symbol size from a physical layer.

In a third aspect, alone or in combination with one or more of the first and second aspects, process 1800 includes obtaining an indication of the PDCP packet size from an application layer, wherein the PDCP packet size is in accordance with an IP packet size and at least one of a service data adaptation protocol header size or a PDCP header size.

In a fourth aspect, alone or in combination with one or more of the first through third aspects, applying the zero padding to the plurality of outer coding symbols comprises applying the zero padding to an end of each outer coding symbol of the plurality of outer coding symbols.

In a fifth aspect, alone or in combination with one or more of the first through fourth aspects, applying the zero padding to the end of each outer coding symbol comprises applying the zero padding to the end of each outer coding symbol in accordance with an outer coding block symbol size minus a size of a last segmented radio link control service data unit.

In a sixth aspect, alone or in combination with one or more of the first through fifth aspects, process 1800 includes adding, by an outer coding sublayer, one or more zero padding symbols to the end of each outer coding symbol of the plurality of outer coding symbols in accordance with a forward error correction encoding.

In a seventh aspect, alone or in combination with one or more of the first through sixth aspects, the plurality of PDCP packets are a plurality of PDCP protocol data units.

In an eighth aspect, alone or in combination with one or more of the first through seventh aspects, the transmitting device is a network node.

In a ninth aspect, alone or in combination with one or more of the first through eighth aspects, the transmitting device is a UE.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, at a receiving device or an apparatus of a receiving device, in accordance with the present disclosure. Example process 1900 is an example where the apparatus or the receiving device (e.g., receiving device 810) performs operations associated with network coding for packet data convergence protocol communications.

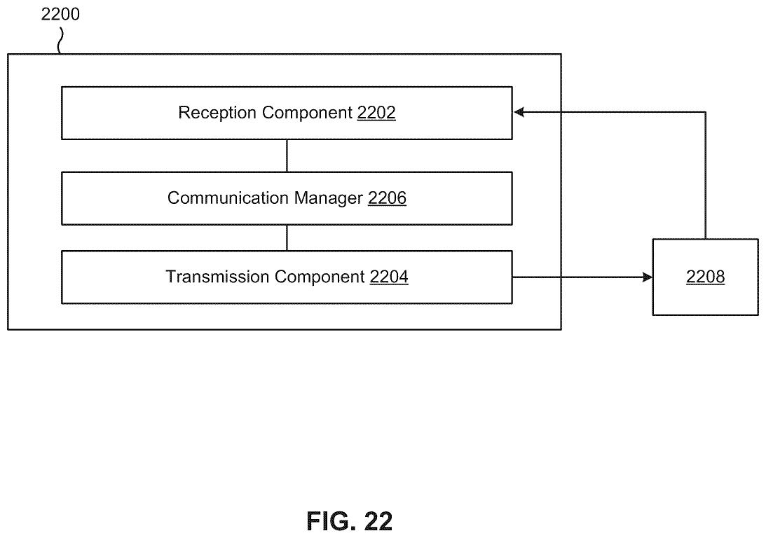

As shown in FIG. 19, in some aspects, process 1900 may include receiving a plurality of RLC packets (block 1910). For example, the receiving device (e.g., using reception component 2202 and/or communication manager 2206, depicted in FIG. 22) may receive a plurality of RLC packets, as described above.

As further shown in FIG. 19, in some aspects, process 1900 may include identifying that the plurality of RLC packets are segmented by an outer coding symbol size (block 1920). For example, the receiving device (e.g., using communication manager 2206, depicted in FIG. 22) may identify that the plurality of RLC packets are segmented by an outer coding symbol size, as described above.

As further shown in FIG. 19, in some aspects, process 1900 may include generating a plurality of source symbols in accordance with the plurality of RLC packets and the outer coding symbol size (block 1930). For example, the receiving device (e.g., using communication manager 2206, depicted in FIG. 22) may generate a plurality of source symbols in accordance with the plurality of RLC packets and the outer coding symbol size, as described above.

As further shown in FIG. 19, in some aspects, process 1900 may include processing the plurality of source symbols to obtain a plurality of PDCP packets (block 1940). For example, the receiving device (e.g., using communication manager 2206, depicted in FIG. 22) may process the plurality of source symbols to obtain a plurality of PDCP packets, as described above.

Process 1900 may include additional aspects, such as any single aspect or any combination of aspects described below and/or in connection with one or more other processes described elsewhere herein.

In a first aspect, process 1900 includes receiving a plurality of parity symbols, wherein generating the plurality of source symbols in accordance with the plurality of RLC packets and the outer coding symbol size comprises generating the plurality of source symbols in accordance with the plurality of RLC packets, the outer coding symbol size, and the plurality of parity symbols.

In a second aspect, alone or in combination with the first aspect, process 1900 includes receiving an outer coding symbol index to be used for error correction of a corresponding outer coding symbol, wherein the outer coding symbol index is based at least in part on an outer coding post-header indication and a segmented outer coding symbol order indication.

In a third aspect, alone or in combination with one or more of the first and second aspects, receiving the outer coding symbol index comprises receiving the outer coding symbol index for a first outer coding symbol of a plurality of outer coding symbols.

In a fourth aspect, alone or in combination with one or more of the first through third aspects, process 1900 includes calculating the outer coding symbol index for a remainder of the outer coding symbols of the plurality of outer coding symbols.

In a fifth aspect, alone or in combination with one or more of the first through fourth aspects, the receiving device is a network node.

In a sixth aspect, alone or in combination with one or more of the first through fifth aspects, the receiving device is a UE.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, at a receiving device or an apparatus of a receiving device, in accordance with the present disclosure. Example process 2000 is an example where the apparatus or the receiving device (e.g., receiving device 810) performs operations associated with network coding for packet data convergence protocol communications.

As shown in FIG. 20, in some aspects, process 2000 may include receiving a plurality of RLC PDUs (block 2010). For example, the receiving device (e.g., using reception component 2202 and/or communication manager 2206, depicted in FIG. 22) may receive a plurality of RLC PDUs, as described above.

As further shown in FIG. 20, in some aspects, process 2000 may include estimating a zero padding length for a plurality of outer coding symbols in accordance with a difference between an RLC PDU size associated with the plurality of RLC PDUs and an outer coding symbol size associated with a plurality of outer coding symbols (block 2020). For example, the receiving device (e.g., using communication manager 2206, depicted in FIG. 22) may estimate a zero padding length for a plurality of outer coding symbols in accordance with a difference between an RLC PDU size associated with the plurality of RLC PDUs and an outer coding symbol size associated with a plurality of outer coding symbols, as described above.

As further shown in FIG. 20, in some aspects, process 2000 may include processing the plurality of outer coding symbols in accordance with the zero padding length to obtain a plurality of PDCP PDUs (block 2030). For example, the receiving device (e.g., using communication manager 2206, depicted in FIG. 22) may process the plurality of outer coding symbols in accordance with the zero padding length to obtain a plurality of PDCP PDUs, as described above.

Process 2000 may include additional aspects, such as any single aspect or any combination of aspects described below and/or in connection with one or more other processes described elsewhere herein.

In a first aspect, process 2000 includes obtaining an indication of the outer coding symbol size from a physical layer.

In a second aspect, alone or in combination with the first aspect, process 2000 includes obtaining an indication of the RLC PDU size from an application layer, wherein the RLC PDU size is based at least in part on an IP PDU size and at least one of a service data adaptation protocol header size or an RLC header size.

In a third aspect, alone or in combination with one or more of the first and second aspects, estimating the zero padding length for the plurality of outer coding symbols comprises estimating the zero padding length for an end of each outer coding symbol of the plurality of outer coding symbols.

In a fourth aspect, alone or in combination with one or more of the first through third aspects, estimating the zero padding length for the end of each outer coding symbol comprises estimating the zero padding length for the end of each outer coding symbol in accordance with the outer coding symbol size and the RLC PDU size.

In a fifth aspect, alone or in combination with one or more of the first through fourth aspects, estimating the zero padding length in accordance with the outer coding symbol size and the RLC PDU size comprises calculating the zero padding length by performing a modulo operation between an RLC protocol data unit size and the outer coding symbol size, and subtracting a result of the modulo operation from the outer coding symbol size.

In a sixth aspect, alone or in combination with one or more of the first through fifth aspects, process 2000 includes generating a plurality of PDCP PDUs in accordance with the plurality of RLC PDUs and RLC header information.

In a seventh aspect, alone or in combination with one or more of the first through sixth aspects, the receiving device is a network node.

In an eighth aspect, alone or in combination with one or more of the first through seventh aspects, the receiving device is a UE.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram of an example apparatus 2100 for wireless communication, in accordance with the present disclosure. The apparatus 2100 may be a transmitting device, or a transmitting device may include the apparatus 2100. In some aspects, the apparatus 2100 includes a reception component 2102, a transmission component 2104, and/or a communication manager 2106, which may be in communication with one another (for example, via one or more buses and/or one or more other components). In some aspects, the communication manager 2106 is the communication manager 140 described in connection with FIG. 1, and the apparatus 2100 may be the UE 120, may include the UE 120, or may be included in the UE 120. In some other aspects, the communication manager 2106 is the communication manager 150 described in connection with FIG. 1, and the apparatus 2100 may be the network node 110, may include the network node 110, or may be included in the network node 110. As shown, the apparatus 2100 may communicate with another apparatus 2108, such as a UE or a network node (such as a CU, a DU, an RU, or a base station), using the reception component 2102 and the transmission component 2104.

In some aspects, the apparatus 2100 may be configured to perform one or more operations described herein in connection with FIGS. 8-15. Additionally, or alternatively, the apparatus 2100 may be configured to perform one or more processes described herein, such as process 1600 of FIG. 16, process 1700 of FIG. 17, process 1800 of FIG. 18, or a combination thereof. In some aspects, the apparatus 2100 and/or one or more components shown in FIG. 21 may include one or more components of the transmitting device described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2102 may receive communications, such as reference signals, control information, data communications, or a combination thereof, from the apparatus 2108. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, one or more modems, one or more demodulators, one or more MIMO detectors, one or more receive processors, one or more controllers/processors, one or more memories, or a combination thereof, of the transmitting device described in connection with FIG. 2.

The transmission component 2104 may transmit communications, such as reference signals, control information, data communications, or a combination thereof, to the apparatus 2108. In some aspects, one or more other components of the apparatus 2100 may generate communications and may provide the generated communications to the transmission component 2104 for transmission to the apparatus 2108. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2108. In some aspects, the transmission component 2104 may include one or more antennas, one or more modems, one or more modulators, one or more transmit MIMO processors, one or more transmit processors, one or more controllers/processors, one or more memories, or a combination thereof, of the transmitting device described in connection with FIG. 2. In some aspects, the transmission component 2104 may be co-located with the reception component 2102 in one or more transceivers.

The communication manager 2106 may support operations of the reception component 2102 and/or the transmission component 2104. For example, the communication manager 2106 may receive information associated with configuring reception of communications by the reception component 2102 and/or transmission of communications by the transmission component 2104. Additionally, or alternatively, the communication manager 2106 may generate and/or provide control information to the reception component 2102 and/or the transmission component 2104 to control reception and/or transmission of communications.

The reception component 2102 may obtain a plurality of PDCP packets. The communication manager 2106 may generate a plurality of source symbols in accordance with applying a forward error correction encoding to the plurality of PDCP packets, wherein the plurality of source symbols are non-segmented outer coding source symbols. The transmission component 2104 may transmit the plurality of source symbols. The communication manager 2106 may generate a plurality of outer coding parity symbols in accordance with the plurality of source symbols.

The reception component 2102 may obtain, from a physical layer, an indication of the outer coding symbol size, wherein the plurality of outer coding parity symbols are based at least in part on the outer coding symbol size. The communication manager 2106 may indicate a source symbol index for a first source symbol of the plurality of source symbols. The communication manager 2106 may refrain from indicating a source symbol index for a remainder of the plurality of source symbols subsequent to the first source symbol. The communication manager 2106 may identify a zero padding length for a last outer coding symbol associated with a PDCP packet of the plurality of PDCP packets to align a size of the last outer coding symbol with a size of the PDCP packet.

The reception component 2102 may obtain a plurality of PDCP packets. The communication manager 2106 may generate a plurality of outer coding symbols in accordance with a maximum PDCP packet size of the plurality of PDCP packets. The communication manager 2106 may adjust a PDCP packet size, for one or more PDCP packets not having the maximum PDCP packet size, to be equal to an outer coding symbol size of the plurality of outer coding symbols.

The transmission component 2104 may transmit a single radio link control layer packet corresponding to each PDCP packet of the plurality of PDCP packets. The communication manager 2106 may apply forward error correction encoding to an outer coding block that includes the plurality of outer coding symbols. The communication manager 2106 may identify one or more zero padding bits to be applied to a PDCP packet of the plurality of PDCP packets that does not have a size that is equal to the maximum PDCP packet size.

The reception component 2102 may obtain a plurality of PDCP packets. The communication manager 2106 may apply, in accordance with a difference between a PDCP packet size associated with the plurality of PDCP packets and an outer coding symbol size associated with a plurality of outer coding symbols, a zero padding to the plurality of outer coding symbols. The transmission component 2104 may transmit the outer coding block in accordance with applying the zero padding to the plurality of outer coding symbols.

The reception component 2102 may obtain an indication of the outer coding symbol size from a physical layer. The reception component 2102 may obtain an indication of the PDCP packet size from an application layer, wherein the PDCP packet size is in accordance with an IP packet size and at least one of a service data adaptation protocol header size or a PDCP header size. The communication manager 2106 may add one or more zero padding symbols to the end of each outer coding symbol of the plurality of outer coding symbols in accordance with a forward error correction encoding.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

FIG. 22 is a diagram of an example apparatus 2200 for wireless communication, in accordance with the present disclosure. The apparatus 2200 may be a receiving device, or a receiving device may include the apparatus 2200. In some aspects, the apparatus 2200 includes a reception component 2202, a transmission component 2204, and/or a communication manager 2206, which may be in communication with one another (for example, via one or more buses and/or one or more other components). In some aspects, the communication manager 2206 is the communication manager 140 described in connection with FIG. 1, and the apparatus 2200 may be the UE 120, may include the UE 120, or may be included in the UE 120. In some other aspects, the communication manager 2206 is the communication manager 150 described in connection with FIG. 1, and the apparatus 2200 may be the network node 110, may include the network node 110, or may be included in the network node 110. As shown, the apparatus 2200 may communicate with another apparatus 2208, such as a UE or a network node (such as a CU, a DU, an RU, or a base station), using the reception component 2202 and the transmission component 2204.

In some aspects, the apparatus 2200 may be configured to perform one or more operations described herein in connection with FIGS. 8-15. Additionally, or alternatively, the apparatus 2200 may be configured to perform one or more processes described herein, such as process 1900 of FIG. 19, process 2000 of FIG. 20, or a combination thereof. In some aspects, the apparatus 2200 and/or one or more components shown in FIG. 22 may include one or more components of the receiving device described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, one or more modems, one or more demodulators, one or more MIMO detectors, one or more receive processors, one or more controllers/processors, one or more memories, or a combination thereof, of the receiving device described in connection with FIG. 2.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2208. In some aspects, the transmission component 2204 may include one or more antennas, one or more modems, one or more modulators, one or more transmit MIMO processors, one or more transmit processors, one or more controllers/processors, one or more memories, or a combination thereof, of the receiving device described in connection with FIG. 2. In some aspects, the transmission component 2204 may be co-located with the reception component 2202 in one or more transceivers.

The communication manager 2206 may support operations of the reception component 2202 and/or the transmission component 2204. For example, the communication manager 2206 may receive information associated with configuring reception of communications by the reception component 2202 and/or transmission of communications by the transmission component 2204. Additionally, or alternatively, the communication manager 2206 may generate and/or provide control information to the reception component 2202 and/or the transmission component 2204 to control reception and/or transmission of communications.

The reception component 2202 may receive a plurality of RLC packets. The communication manager 2206 may identify that the plurality of RLC packets are segmented by an outer coding symbol size. The communication manager 2206 may generate a plurality of source symbols in accordance with the plurality of RLC packets and the outer coding symbol size.

The reception component 2202 may receive a plurality of parity symbols, wherein generating the plurality of source symbols in accordance with the plurality of RLC packets and the outer coding symbol size comprises generating the plurality of source symbols in accordance with the plurality of RLC packets, the outer coding symbol size, and the plurality of parity symbols. The reception component 2202 may receive an outer coding symbol index to be used for error correction of a corresponding outer coding symbol, wherein the outer coding symbol index is based at least in part on an outer coding post-header indication and a segmented outer coding symbol order indication. The communication manager 2206 may calculate the outer coding symbol index for a remainder of the outer coding symbols of the plurality of outer coding symbols.

The reception component 2202 may receive a plurality of RLC PDUs. The communication manager 2206 may identify a difference between an RLC PDU size associated with the plurality of RLC PDUs and an outer coding symbol size associated with a plurality of outer coding symbols. The communication manager 2206 may estimate a zero padding length for a plurality of outer coding symbols in accordance with a difference between an RLC PDU size associated with the plurality of RLC PDUs and an outer coding symbol size associated with a plurality of outer coding symbols.

The reception component 2202 may obtain an indication of the outer coding symbol size from a physical layer. The reception component 2202 may obtain an indication of the RLC PDU size from an application layer, wherein the RLC PDU size is based at least in part on an IP PDU size and at least one of a service data adaptation protocol header size or an RLC header size. The communication manager 2206 may generate a plurality of PDCP PDUs in accordance with the plurality of RLC PDUs and RLC header information.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

The following provides an overview of some Aspects of the present disclosure:

Aspect 1: A method of wireless communication performed by a transmitting device, comprising: obtaining a plurality of packet data convergence protocol (PDCP) packets; generating a plurality of source symbols in accordance with applying a forward error correction encoding to the plurality of PDCP packets, wherein the plurality of source symbols are non-segmented outer coding source symbols; and transmitting, by a radio link control layer, the plurality of source symbols.

Aspect 2: The method of Aspect 1, further comprising generating a plurality of outer coding parity symbols in accordance with the plurality of source symbols.

Aspect 3: The method of Aspect 2, wherein generating the plurality of outer coding parity symbols comprises generating the plurality of outer coding parity symbols in accordance with the plurality of source symbols and an outer coding symbol size.

Aspect 4: The method of Aspect 3, further comprising obtaining, from a physical layer, an indication of the outer coding symbol size, wherein the plurality of outer coding parity symbols are based at least in part on the outer coding symbol size.

Aspect 5: The method of any of Aspects 1-4, wherein a source symbol size associated with the plurality of source symbols is smaller than a PDCP packet size associated with the plurality of PDCP packets.

Aspect 6: The method of any of Aspects 1-5, further comprising indicating a source symbol index for a first source symbol of the plurality of source symbols.

Aspect 7: The method of Aspect 6, further comprising refraining from indicating a source symbol index for a remainder of the plurality of source symbols subsequent to the first source symbol.

Aspect 8: The method of any of Aspects 1-7, further comprising identifying a zero padding length for a last outer coding symbol associated with a PDCP packet of the plurality of PDCP packets to align a size of the last outer coding symbol with a size of the PDCP packet.

Aspect 9: The method of Aspect 8, wherein identifying the zero padding length for the last outer coding symbol comprises aligning the size of the last outer coding symbol with the size of the PDCP packet based at least in part on the zero padding length.

Aspect 10: The method of any of Aspects 1-9, wherein the plurality of PDCP packets are a plurality of PDCP protocol data units.

Aspect 11: The method of any of Aspects 1-10, wherein the transmitting device is a network node.

Aspect 12: The method of any of Aspects 1-11, wherein the transmitting device is a user equipment.

Aspect 13: A method of wireless communication performed by a transmitting device, comprising: obtaining a plurality of packet data convergence protocol (PDCP) packets; generating a plurality of outer coding symbols in accordance with a maximum PDCP packet size of the plurality of PDCP packets; adjusting a PDCP packet size, for one or more PDCP packets not having the maximum PDCP packet size, to be equal to an outer coding symbol size of the plurality of outer coding symbols; and transmitting the plurality of PDCP packets in accordance with adjusting the PDCP packet size.

Aspect 14: The method of Aspect 13, further comprising transmitting a single radio link control layer packet corresponding to each PDCP packet of the plurality of PDCP packets.

Aspect 15: The method of Aspect 14, wherein transmitting the single radio link control layer packet comprises transmitting the single radio link control layer packet corresponding to each PDCP packet of the plurality of PDCP packets without performing a concatenation operation or a segmentation operation.

Aspect 16: The method of Aspect 14, further comprising applying forward error correction encoding to an outer coding block that includes the plurality of outer coding symbols.

Aspect 17: The method of any of Aspects 13-16, further comprising identifying one or more zero padding bits to be applied to a PDCP packet of the plurality of PDCP packets that does not have a size that is equal to the maximum PDCP packet size.

Aspect 18: The method of Aspect 17, wherein identifying the one or more zero padding bits to be applied to the PDCP packet comprises identifying one or more zero padding bits to be applied to the PDCP packet to align a size of the PDCP packet with the maximum PDCP packet size.

Aspect 19: The method of any of Aspects 13-18, wherein the plurality of PDCP packets are a plurality of PDCP protocol data units.

Aspect 20: The method of any of Aspects 13-19, wherein the transmitting device is a network node.

Aspect 21: The method of any of Aspects 13-20, wherein the transmitting device is a user equipment.

Aspect 22: The method of any of Aspects 13-21, wherein the one or more processors are further configured to cause the transmitting device to receive, from a network node, an indication of a maximum protocol data unit size of a plurality of PDCP protocol data units.

Aspect 23: The method of any of Aspects 13-22, wherein the plurality of PDCP packets are associated with at least one of a protocol data unit set or a protocol data unit burst.

Aspect 24: A method of wireless communication performed by a transmitting device, comprising: obtaining a plurality of packet data convergence protocol (PDCP) packets; applying, in accordance with a difference between a PDCP packet size associated with the plurality of PDCP packets and an outer coding symbol size associated with a plurality of outer coding symbols, a zero padding to the plurality of outer coding symbols; and transmitting the outer coding block in accordance with applying the zero padding to the plurality of outer coding symbols.

Aspect 25: The method of Aspect 24, wherein applying the zero padding to the plurality of outer coding symbols comprises adding one or more zero padding bits to the plurality of outer coding symbols, and wherein transmitting the outer coding block comprises refraining from transmitting the one or more zero padding bits associated with the plurality of outer coding symbols.

Aspect 26: The method of any of Aspects 24-25, further comprising obtaining an indication of the outer coding symbol size from a physical layer.

Aspect 27: The method of any of Aspects 24-26, further comprising obtaining an indication of the PDCP packet size from an application layer, wherein the PDCP packet size is in accordance with an Internet protocol packet size and at least one of a service data adaptation protocol header size or a PDCP header size.

Aspect 28: The method of any of Aspects 24-27, wherein applying the zero padding to the plurality of outer coding symbols comprises applying the zero padding to an end of each outer coding symbol of the plurality of outer coding symbols.

Aspect 29: The method of Aspect 28, wherein applying the zero padding to the end of each outer coding symbol comprises applying the zero padding to the end of each outer coding symbol in accordance with an outer coding block symbol size minus a size of a last segmented radio link control service data unit.

Aspect 30: The method of Aspect 28, further comprising adding, by an outer coding sublayer, one or more zero padding symbols to the end of each outer coding symbol of the plurality of outer coding symbols in accordance with a forward error correction encoding.

Aspect 31: The method of any of Aspects 24-30, wherein the plurality of PDCP packets are a plurality of PDCP protocol data units.

Aspect 32: The method of any of Aspects 24-31, wherein the transmitting device is a network node.

Aspect 33: The method of any of Aspects 24-32, wherein the transmitting device is a user equipment.

Aspect 34: A method of wireless communication performed by a receiving device, comprising: receiving a plurality of radio link control (RLC) packets; identifying that the plurality of RLC packets are segmented by an outer coding symbol size; generating a plurality of source symbols in accordance with the plurality of RLC packets and the outer coding symbol size; and processing the plurality of source symbols to obtain a plurality of packet data convergence protocol (PDCP) packets.

Aspect 35: The method of Aspect 34, further comprising receiving a plurality of parity symbols, wherein generating the plurality of source symbols in accordance with the plurality of RLC packets and the outer coding symbol size comprises generating the plurality of source symbols in accordance with the plurality of RLC packets, the outer coding symbol size, and the plurality of parity symbols.

Aspect 36: The method of any of Aspects 34-35, further comprising receiving an outer coding symbol index to be used for error correction of a corresponding outer coding symbol, wherein the outer coding symbol index is based at least in part on an outer coding post-header indication and a segmented outer coding symbol order indication.

Aspect 37: The method of Aspect 36, wherein receiving the outer coding symbol index comprises receiving the outer coding symbol index for a first outer coding symbol of a plurality of outer coding symbols.

Aspect 38: The method of Aspect 37, further comprising calculating the outer coding symbol index for a remainder of the outer coding symbols of the plurality of outer coding symbols.

Aspect 39: The method of any of Aspects 34-38, wherein the receiving device is a network node.

Aspect 40: The method of any of Aspects 34-39, wherein the receiving device is a user equipment.

Aspect 41, The method of any of Aspects 34-40, wherein the plurality of PDCP packets are associated with at least one of a protocol data unit set or a protocol data unit burst.

Aspect 42: A method of wireless communication performed by a receiving device, comprising: receiving a plurality of radio link control (RLC) protocol data units (PDUs); estimating a zero padding length for a plurality of outer coding symbols in accordance with a difference between an RLC PDU size associated with the plurality of RLC PDUs and an outer coding symbol size associated with a plurality of outer coding symbols; and processing the plurality of outer coding symbols in accordance with the zero padding length to obtain a plurality of packet data convergence protocol (PDCP) PDUs.

Aspect 43: The method of Aspect 42, further comprising obtaining an indication of the outer coding symbol size from a physical layer.

Aspect 44: The method of any of Aspects 42-43, further comprising obtaining an indication of the RLC PDU size from an application layer, wherein the RLC PDU size is based at least in part on an Internet Protocol PDU size and at least one of a service data adaptation protocol header size or an RLC header size.

Aspect 45: The method of any of Aspects 42-44, wherein estimating the zero padding length for the plurality of outer coding symbols comprises estimating the zero padding length for an end of each outer coding symbol of the plurality of outer coding symbols.

Aspect 46: The method of Aspect 45, wherein estimating the zero padding length for the end of each outer coding symbol comprises estimating the zero padding length for the end of each outer coding symbol in accordance with the outer coding symbol size and the RLC PDU size.

Aspect 47: The method of Aspect 46, wherein estimating the zero padding length in accordance with the outer coding symbol size and the RLC PDU size comprises calculating the zero padding length by performing a modulo operation between an RLC protocol data unit size and the outer coding symbol size, and subtracting a result of the modulo operation from the outer coding symbol size.

Aspect 48: The method of any of Aspects 42-47, further comprising generating a plurality of packet data convergence protocol (PDCP) PDUs in accordance with the plurality of RLC PDUs and RLC header information.

Aspect 49: The method of any of Aspects 42-48, wherein the receiving device is a network node.

Aspect 50: The method of any of Aspects 42-49, wherein the receiving device is a user equipment.

Aspect 51: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-50.

Aspect 52: An apparatus for wireless communication at a device, the apparatus comprising one or more memories and one or more processors coupled to the one or more memories, the one or more processors configured to cause the device to perform the method of one or more of Aspects 1-50.

Aspect 53: An apparatus for wireless communication, the apparatus comprising at least one means for performing the method of one or more of Aspects 1-50.

Aspect 54: A non-transitory computer-readable medium storing code for wireless communication, the code comprising instructions executable by one or more processors to perform the method of one or more of Aspects 1-50.

Aspect 55: A non-transitory computer-readable medium storing a set of instructions for wireless communication, the set of instructions comprising one or more instructions that, when executed by one or more processors of a device, cause the device to perform the method of one or more of Aspects 1-50.

Aspect 56: A device for wireless communication, the device comprising a processing system that includes one or more processors and one or more memories coupled with the one or more processors, the processing system configured to cause the device to perform the method of one or more of Aspects 1-50.

Aspect 57: An apparatus for wireless communication at a device, the apparatus comprising one or more memories and one or more processors coupled to the one or more memories, the one or more processors individually or collectively configured to cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a transmitting device, comprising:
one or more memories; and
one or more processors coupled to the one or more memories, the one or more processors individually or collectively configured to cause the transmitting device to:
obtain a plurality of packet data convergence protocol (PDCP) packets;
generate a plurality of source symbols in accordance with applying a forward error correction encoding to the plurality of PDCP packets, wherein the plurality of source symbols are non-segmented outer coding source symbols; and
transmit the plurality of source symbols.

2. The apparatus of claim 1, wherein the one or more processors are further configured to cause the transmitting device to generate a plurality of outer coding parity symbols in accordance with the plurality of source symbols.

3. The apparatus of claim 2, wherein the one or more processors, to cause the transmitting device to generate the plurality of outer coding parity symbols, are configured to cause the transmitting device to generate the plurality of outer coding parity symbols in accordance with the plurality of source symbols and an outer coding symbol size.

4. The apparatus of claim 3, wherein the one or more processors are further configured to cause the transmitting device to obtain, from a physical layer, an indication of the outer coding symbol size, wherein the plurality of outer coding parity symbols are based at least in part on the outer coding symbol size.

5. The apparatus of claim 1, wherein a source symbol size associated with the plurality of source symbols is smaller than a PDCP packet size associated with the plurality of PDCP packets.

6. The apparatus of claim 1, wherein the one or more processors are further configured to cause the transmitting device to indicate a source symbol index for a first source symbol of the plurality of source symbols.

7. The apparatus of claim 6, wherein the one or more processors are further configured to cause the transmitting device to refrain from indicating a source symbol index for a remainder of the plurality of source symbols subsequent to the first source symbol.

8. The apparatus of claim 1, wherein the one or more processors are further configured to cause the transmitting device to identify a zero padding length for a last outer coding symbol associated with a PDCP packet of the plurality of PDCP packets to align a size of the last outer coding symbol with a size of the PDCP packet.

9. The apparatus of claim 1, wherein the plurality of PDCP packets are associated with at least one of a protocol data unit set or a protocol data unit burst.

10. An apparatus for wireless communication at a receiving device, comprising:
one or more memories; and
one or more processors coupled to the one or more memories, the one or more processors individually or collectively configured to cause the receiving device to:
receive a plurality of radio link control (RLC) packets;
identify that the plurality of RLC packets are segmented by an outer coding symbol size;
generate a plurality of source symbols in accordance with the plurality of RLC packets and the outer coding symbol size; and
process the plurality of source symbols to obtain a plurality of packet data convergence protocol (PDCP) packets.

11. The apparatus of claim 10, wherein the one or more processors are further configured to cause the receiving device to receive a plurality of parity symbols, wherein generating the plurality of source symbols in accordance with the plurality of RLC packets and the outer coding symbol size comprises generating the plurality of source symbols in accordance with the plurality of RLC packets, the outer coding symbol size, and the plurality of parity symbols.

12. The apparatus of claim 10, wherein the one or more processors are further configured to cause the receiving device to receive an outer coding symbol index to be used for error correction of a corresponding outer coding symbol, wherein the outer coding symbol index is based at least in part on an outer coding post-header indication and a segmented outer coding symbol order indication.

13. The apparatus of claim 12, wherein the one or more processors, to cause the receiving device to receive the outer coding symbol index, are configured to cause the receiving device to receive the outer coding symbol index for a first outer coding symbol of a plurality of outer coding symbols.

14. The apparatus of claim 13, wherein the one or more processors are further configured to cause the receiving device to calculate the outer coding symbol index for a remainder of the outer coding symbols of the plurality of outer coding symbols.

15. The apparatus of claim 10, wherein the plurality of PDCP packets are associated with at least one of a protocol data unit set or a protocol data unit burst.

16. An apparatus for wireless communication at a transmitting device, comprising:
one or more memories; and
one or more processors coupled to the one or more memories, the one or more processors individually or collectively configured to cause the transmitting device to:
obtain a plurality of packet data convergence protocol (PDCP) packets;
generate a plurality of outer coding symbols in accordance with a maximum PDCP packet size of the plurality of PDCP packets;
adjust a PDCP packet size, for one or more PDCP packets not having the maximum PDCP packet size, to be equal to an outer coding symbol size of the plurality of outer coding symbols; and
transmit the plurality of PDCP packets in accordance with adjusting the PDCP packet size.

17. The apparatus of claim 16, wherein the one or more processors, to cause the transmitting device to transmit the plurality of PDCP packets, are configured to cause the transmitting device to transmit a single radio link control layer packet corresponding to each PDCP packet of the plurality of PDCP packets.

18. The apparatus of claim 17, wherein the one or more processors, to cause the transmitting device to transmit the single radio link control layer packet, are configured to cause the transmitting device to transmit the single radio link control layer packet corresponding to each PDCP packet of the plurality of PDCP packets without performing a concatenation operation or a segmentation operation.

19. The apparatus of claim 16, wherein the one or more processors are further configured to cause the transmitting device to identify one or more zero padding bits to be applied to a PDCP packet of the plurality of PDCP packets that does not have a size that is equal to the maximum PDCP packet size.

20. The apparatus of claim 16, wherein the one or more processors are further configured to cause the transmitting device to receive, from a network node, an indication of a maximum protocol data unit size of a plurality of PDCP protocol data units.
